(19) United States
(12) Patent Application Publication
(10) Pub. No.: US 2019/0124413 A1
(43) Pub. Date: Apr. 25, 2019

(54) SYSTEMS AND METHODS FOR SIGNALING OF EMERGENCY ALERTS

(71) Applicant: Sharp Kabushiki Kaisha, Sakai City, Osaka (JP)

(72) Inventors: Sheau NG, Camas, WA (US); Sachin G. DESHPANDE, Camas, WA (US); Kiran Mukesh MISRA, Camas, WA (US); Christopher Andrew SEGALL, Camas, WA (US)

(21) Appl. No.: 16/094,521

(22) PCT Filed: Apr. 26, 2017
(86) PCT No.: PCT/JP2017/016463

§ 371 Date: Oct. 18, 2018

Related U.S. Application Data
(60) Provisional application No. 62/329,182, filed on Apr. 28, 2016.
(60) Provisional application No. 62/349,058, filed on Jun. 12, 2016.
(60) Provisional application No. 62/351,261, filed on Jun. 16, 2016.
(60) Provisional application No. 62/354,646, filed on Jun. 24, 2016.

(51) Int. Cl. H04N 21/81; H04N 21/434; H04N 21/2362; H04H 20/59; H04H 20/93

(52) U.S. Cl. CPC H04N 21/814; H04N 21/4345; H04H 20/93; H04H 20/59; H04N 21/2362

(57) ABSTRACT

A device may be configured to receive a low level signaling notification fragment from a broadcast stream. The device may parse the notification fragment. The device may determine whether an emergency alert message is directly integrated into a media component of a service based on the notification fragment. The device may modify the presentation of the service based on the determination of whether an emergency alert message is directly integrated into a media component forming the service.

### TECHNICAL FIELD

The present disclosure relates to the field of interactive television.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular telephones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packetswitched networks, including bidirectional networks, such as Internet Protocol (IP) networks and unidirectional networks, such as digital broadcast networks.

Digital media content may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards. The ATSC 3.0 suite of standards seek to support a wide range of diverse services through diverse delivery mechanisms. For example, the ATSC 3.0 suite of standards seeks to support broadcast multimedia delivery, so-called broadcast streaming/file download multimedia delivery, so-called broadband streaming/file download multimedia delivery, and combinations thereof (i.e., “hybrid services”). An example of a hybrid service contemplated for the ATSC 3.0 suite of standards includes a receiver device receiving an over-the-air video broadcast (e.g., through a unidirectional transport) and receiving a synchronized secondary audio presentation (e.g., a secondary language) from an online media service provider through a packet switched network (i.e., through a bidirectional transport). In addition to defining how digital media content may be transmitted from a source to a receiver device, transmission standards may specify how emergency alert messages may be communicated from a source to a receiver device. Current techniques for communicating emergency alert messages and other onscreen notifications may be less than ideal.

### SUMMARY OF INVENTION

According to one example of the disclosure, a method for signaling whether a message is directly integrated into a video component forming a service is disclosed, the method comprising: signaling a value indicating an instance of a low level notification fragment has a type associated with messages directly integrated into a video component forming a service; and signaling values for one or more syntax elements included in the instance of the notification fragment indicating whether a message is directly integrated into a video component for a particular service.

According to one example of the disclosure, a method for modifying the presentation of a service in response to a notification message is disclosed, the method comprising: receiving an instance of a low level notification fragment having a type associated with messages directly integrated into a video component forming a service; determining that a notification message is directly integrated into a media component forming a service by parsing information from the notification fragment; and modifying the presentation of the service based on the determination of whether a notification message is directly integrated into a media component forming the service.

According to one example of the disclosure, a device comprising a non-transitory computer readable storage medium and one or more processors is disclosed, the device configured to: receive an instance of a low level notification fragment having a type associated with messages directly integrated into a video component forming a service;

determine that a notification message is directly integrated into a media component forming a service by parsing information from the notification fragment; and modify the presentation of the service based on the determination of whether an notification message is directly integrated into a media component forming the service.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example of content delivery protocol model according to one or more techniques of this disclosure.

FIG. 2 is a block diagram illustrating an example of a system that may implement one or more techniques of this disclosure.

FIG. 3 is a block diagram illustrating an example of a service distribution engine that may implement one or more techniques of this disclosure.

FIG. 4 is a computer program listing illustrating an example of an emergency communication message schema according to one or more techniques of this disclosure.

FIG. 5 is a computer program listing illustrating an example of emergency communication messages formatted according to a schema according to one or more techniques of this disclosure.

FIG. 6 is a computer program listing illustrating an example of an emergency communication message schema according to one or more techniques of this disclosure.

FIG. 7 is a computer program listing illustrating an example of emergency communication message formatted according to a schema according to one or more techniques of this disclosure.

FIG. 8A is computer program listings illustrating examples of emergency communication message formatted according to a schema according to one or more techniques of this disclosure.

FIG. 8B is computer program listings illustrating examples of emergency communication message formatted according to a schema according to one or more techniques of this disclosure.

FIG. 8C is computer program listings illustrating examples of emergency communication message formatted according to a schema according to one or more techniques of this disclosure.

FIG. 8D is computer program listings illustrating examples of emergency communication message formatted according to a schema according to one or more techniques of this disclosure.

FIG. 9 is a computer program listing illustrating an example of an emergency communication message formatted according to a schema according to one or more techniques of this disclosure.

FIG. 10 is a computer program listing illustrating an example of emergency communication message formatted according to a schema according to one or more techniques of this disclosure.

FIG. 11 is a computer program listing illustrating an example of an emergency communication message schema according to one or more techniques of this disclosure.

FIG. 12 is a block diagram illustrating an example of a receiver device that may implement one or more techniques of this disclosure.

FIG. 13 is a computer program listing illustrating an example of an on-screen notification communication message schema according to one or more techniques of this disclosure.

FIG. 14 is a computer program listing illustrating an example of onscreen notification communication messages formatted according to a schema according to one or more techniques of this disclosure.

FIG. 15 is a computer program listing illustrating an example of an on-screen notification communication message schema according to one or more techniques of this disclosure.

### DESCRIPTION OF EMBODIMENTS

In general, this disclosure describes techniques for signaling (or signalling) information associated with notification messages, including, for example, emergency alert messages. In particular, the techniques described herein may be used for signaling a type of emergency alert message, timing information associated with an emergency alert message, and/or other information associated with an emergency alert message. In some cases, a receiver device may be able to parse information associated with emergency alert messages and cause the presentation/rendering of digital media content to be modified, such that the corresponding emergency message alert is more apparent to a user. For example, a receiver device may be configured to close or temporarily suspend an application, if signaling information indicates the presence of a particular type of emergency alert message. It should be noted that although the techniques described herein, in some examples, are described with respect to emergency alerts, the techniques described herein may be more generally applicable to other types of alerts and messages. For example, an advertisement server may be configured to generate supplemental content (e.g., a banner advertisement) that may be presented in conjunction with multimedia content (e.g., a television program). In a manner similar to that described herein with respect to emergency alert messages, information associated with advertising messages, and the like may be signaled according to the techniques described herein. It should be noted that although in some examples the techniques of this disclosure are described with respect to ATSC standards, the techniques described herein are generally applicable to any transmission standard. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standards, World Wide Web Consortium (W3C) standards, Universal Plug and Play (UPnP) standards, and other video encoding standards. Further, it should be noted that incorporation by reference of documents herein is for descriptive purposes and should not be constructed to limit and/or create ambiguity with respect to terms used herein. For example, in the case where one incorporated reference provides a different definition of a term than another incorporated reference and/or as the term is used herein, the term should be interpreted in a manner that broadly includes each respective definition and/or in a manner that includes each of the particular definitions in the alternative.

According to one example of the disclosure, a method for signaling information associated with an emergency alert message comprises signaling a syntax element indicating that an emergency alert message is directly integrated into a media component forming a service and signaling one of more of the following syntax elements: a syntax element identifying a data channel corresponding to the service, a syntax element uniquely identifying the service within the data channel, a syntax element indicating a start time of an emergency alert message, and a syntax element indicating a duration of an emergency alert message.

According to another example of the disclosure, a device for signaling information associated with an emergency alert message comprises one or more processors configured to signal a syntax element indicating that an emergency alert message is directly integrated into a media component forming a service and signal one of more of the following syntax elements: a syntax element identifying a data channel corresponding to the service, a syntax element uniquely identifying the service within the data channel, a syntax element indicating a start time of an emergency alert message, and a syntax element indicating a duration of an emergency alert message.

According to another example of the disclosure, an apparatus comprises means for signaling a syntax element indicating that an emergency alert message is directly integrated into a media component forming a service and means for signaling one of more of the following syntax elements: a syntax element identifying a data channel corresponding to the service, a syntax element uniquely identifying the service within the data channel, a syntax element indicating a start time of an emergency alert message, and a syntax element indicating a duration of an emergency alert message.

According to another example of the disclosure, a non-transitory computer-readable storage medium comprises instructions stored thereon that upon execution cause one or more processors of a device to signal a syntax element indicating that an emergency alert message is directly integrated into a media component forming a service and signal one of more of the following syntax elements: a syntax element identifying a data channel corresponding to the service, a syntax element uniquely identifying the service within the data channel, a syntax element indicating a start time of an emergency alert message, and a syntax element indicating a duration of an emergency alert message.

According to one example of the disclosure, a method for modifying the presentation of a service in response to an emergency alert message comprises receiving a signaling notification fragment from a broadcast stream, determining that an emergency alert message is directly integrated into a media component forming a service by parsing information from the a signaling notification fragment, and modifying the presentation of the service based on the determination of whether an emergency alert message is directly integrated into a media component forming the service.

According to another example of the disclosure, a device for modifying the presentation of a service in response to an emergency alert message comprises one or more processors configured to receive a signaling notification fragment from a broadcast stream, determine that an emergency alert message is directly integrated into a media component forming a service by parsing information from the a signaling notification fragment, and modify the presentation of the service based on the determination of whether an emergency alert message is directly integrated into a media component forming the service.

According to another example of the disclosure, an apparatus comprises means for receiving a signaling notification fragment from a broadcast stream, means for determining that an emergency alert message is directly integrated into a media component forming a service by parsing information from the a signaling notification fragment, and means for modifying the presentation of the service based on the determination of whether an emergency alert message is directly integrated into a media component forming the service.

According to another example of the disclosure, a non-transitory computer-readable storage medium comprises instructions stored thereon that upon execution cause one or more processors of a device to receive a signaling notification fragment from a broadcast stream, determine that an emergency alert message is directly integrated into a media component forming a service by parsing information from the a signaling notification fragment, and modify the presentation of the service based on the determination of whether an emergency alert message is directly integrated into a media component forming the service.

Transmission standards may define how emergency alerts may be communicated from a service provider to receiver devices. Emergency alerts are typically generated by an emergency authority and transmitted to a service provider. An emergency authority may be included as part of a government agency. For example, emergency authorities may include the United States National Weather Service, the United States Department of Homeland Security, local and regional agencies (e.g., police and fire departments) and the like. Emergency alerts may include information about a current or anticipated emergency. Information may include information that is intended to further the protection of life, health, safety, and property, and may include critical details regarding the emergency and how to respond to the emergency. Examples of the types of emergencies that may be associated with an emergency alert include tornadoes, hurricanes, floods, tidal waves, earthquakes, icing conditions, heavy snows, widespread fires, discharge of toxic gases, widespread power failures, industrial explosions, civil disorders, warnings and watches of impending changes in weather, and the like.

A service provider, such as, for example, a television broadcaster (e.g., a regional network affiliate), a multi-channel video program distributor (MVPD) (e.g., a cable television service operator, a satellite television service operator, an Internet Protocol Television (IPTV) service operator), and the like, may generate one or more emergency alert messages for distribution to receiver devices. Emergency alerts and/or emergency alert messages may include one or more of text (e.g., “Severe Weather Alert”), images (e.g., a weather map), audio content (e.g., warning tones, audio messages, etc.), video content, and/or electronic documents. In some examples, emergency alert messages may be directly integrated into the presentation of a multimedia content (i.e., “burned-in” to video as a scrolling banner or mixed with an audio track). Further, in some examples, emergency alerts and/or emergency alert messages may include Uniform Resource Identifiers (URIs). For example, an emergency alert message may include Universal Resource Locators (URLs) that identify where additional information (e.g., video, audio, text, images, etc.) related to the emergency may be obtained (e.g., the IP address of a server including a document describing the emergency). A receiver device receiving an emergency alert message including a URL (either through a unidirectional broadcast or through a bidirectional broadband connection) may obtain a document describing an emergency alert, parse the document, and display information included in the document on a display (e.g., generate and overlay a scrolling banner on video presentation, render images, play audio messages). In some examples, documents describing an emergency alert may be defined according to a protocol, including, for example, Common Alerting Protocol (CAP). Protocols may specify one or more schemas for formatting an emergency alert message, such as, for example, schemas based on Hypertext Markup Language (HTML), Dynamic HTML, Extensible Markup Language (XML), JavaScript Object Notation (JSON), and Cascading Style Sheets (CSS). Common Alerting Protocol, Version 1.2, which is described in OASIS: “Common Alerting Protocol” Version 1.2, 1 Jul. 2010, (hereinafter “CAP Version 1.2”) which is incorporated by reference herein, provides an example of how an emergency alert message may be formatted according to a XML schema.

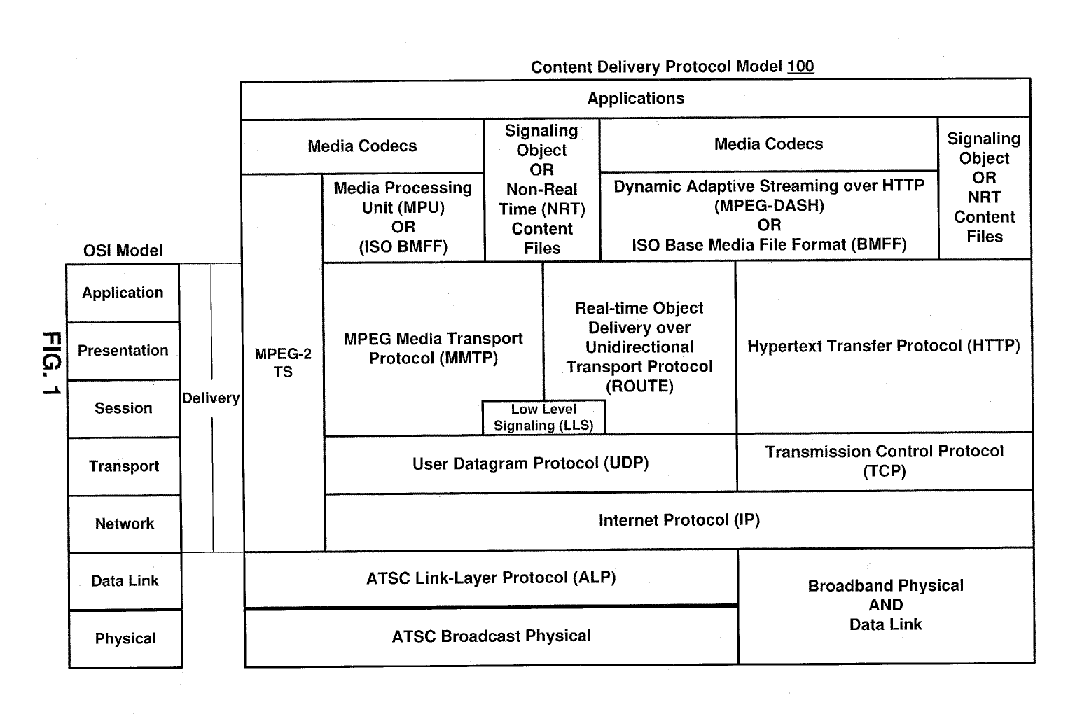

Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model illustrated in FIG. 1. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as link layer, may refer to an abstraction used prior to physical layer processing at a sending side and after physical layer reception at a receiving side. As used herein, a link layer may refer to an abstraction used to transport data from a network layer to a physical layer at a sending side and used to transport data from a physical layer to a network layer at a receiving side. It should be noted that a sending side and a receiving side are logical roles and a single device may operate as both a sending side in one instance and as a receiving side in another instance. A link layer may abstract various types of data (e.g., video, audio, or application files) encapsulated in particular packet types (e.g., Motion Picture Expert Group-Transport Stream (MPEG-TS) packets, Internet Protocol Version 4 (IPv4) packets, etc.) into a single generic format for processing by a physical layer. A network layer may generally refer to a layer at which logical addressing occurs. That is, a network layer may generally provide addressing information (e.g., Internet Protocol (IP) addresses, URLs, URIs, etc.) such that data packets can be delivered to a particular node (e.g., a computing device) within a network. As used herein, the term network layer may refer to a layer above a link layer and/or a layer having data in a structure such that it may be received for link layer processing. Each of a transport layer, a session layer, a presentation layer, and an application layer may define how data is delivered for use by a user application.

Transmission standards, including transmission standards currently under development, may include a content delivery protocol model specifying supported protocols for each layer and may further define one or more specific layer implementations. Referring again to FIG. 1, an example content delivery protocol model is illustrated. In the example illustrated in FIG. 1, content delivery protocol model 100 is generally aligned with the 7-layer OSI model for illustration purposes. It should be noted that such an illustration should not be construed to limit implementations of the content delivery protocol model 100 and/or the techniques described herein. Content delivery protocol model 100 may generally correspond to the currently proposed content delivery protocol model for the ATSC 3.0 suite of standards. Further, the techniques described herein may be implemented in a system configured to operate based on content delivery protocol model 100.

The ATSC 3.0 suite of standards includes ATSC Standard A/321, System Discovery and Signaling Doc. A/321:2016, 23 Mar. 2016 (hereinafter “A/321”), which is incorporated by reference herein in its entirety. A/321 describes the initial entry point of a physical layer waveform of an ATSC 3.0 unidirectional physical layer implementation. Further, aspects of the ATSC 3.0 suite of standards currently under development are described in Candidate Standards, revisions thereto, and Working Drafts (WD), each of which may include proposed aspects for inclusion in a published (i.e., “final” or “adopted”) version of an ATSC 3.0 standard. For example, ATSC Standard: Physical Layer Protocol, Doc. 532-230r45, 6 Sep. 2015, which is incorporated by reference herein in its entirety, describes a proposed unidirectional physical layer for ATSC 3.0. The proposed ATSC 3.0 unidirectional physical layer includes a physical layer frame structure including a defined bootstrap, preamble, and data payload structure including one or more physical layer pipes (PLPs). A PLP may generally refer to a logical structure within an RF channel or a portion of an RF channel. The proposed ATSC 3.0 suite of standards refers to the abstraction for an RF Channel as a Broadcast Stream. The proposed ATSC 3.0 suite of standards further provides that a PLP is identified by a PLP identifier (PLPID), which is unique within the Broadcast Stream it belongs to. That is, a PLP may include a portion of an RF channel (e.g., a RF channel identified by a geographic area and frequency) having particular modulation and coding parameters.

The proposed ATSC 3.0 unidirectional physical layer provides that a single RF channel can contain one or more PLPs and each PLP may carry one or more services. In one example, multiple PLPs may carry a single service. In the proposed ATSC 3.0 suite of standards, the term service may be used to refer to a collection of media components presented to the user in aggregate (e.g., a video component, an audio component, and a sub-title component), where components may be of multiple media types, where a service can be either continuous or intermittent, where a service can be a real time service (e.g., multimedia presentation corresponding to a live event) or a non-real time service (e.g., a video on demand service, an electronic service guide service), and where a real time service may include a sequence of television programs. Services may include application based features. Application based features may include service components including an application, optional files to be used by the application, and optional notifications directing the application to take particular actions at particular times. In one example, an application may be a collection of documents constituting an enhanced or interactive service. The documents of an application may include HTML, JavaScript, CSS, XML, and/or multimedia files. It should be noted that the proposed ATSC 3.0 suite of standards specifies that new types of services may be defined in future versions. Thus, as used herein the term service may refer to a service described with respect to the proposed ATSC 3.0 suite of standards and/or other types of digital media services. As described above, a service provider may receive an emergency alert from an emergency authority and generate emergency alert messages that may be distributed to receiver devices in conjunction with a service. A service provider may generate an emergency alert message that is integrated into a multimedia presentation and/or generate an emergency alert message as part of an application based enhancement. For example, emergency information may be displayed in video as text (which may be referred to as emergency on-screen text information), and may include, for example, a scrolling banner (which may be referred to as a crawl). The scrolling banner may be received by the receiver device as a text message burned-in to a video presentation (e.g., as an onscreen emergency alert message) and/or as text included in a document (e.g., a CAP XML fragment). It should be noted that the techniques described herein may be generally applicable to any type of messaging that a service provider integrates into a multimedia presentation, i.e., the techniques described herein may be generally applicable to “burn-in” signaling.

Referring to FIG. 1, content delivery protocol model 100 supports streaming and/or file download through the ATSC Broadcast Physical layer using MPEG Media Transport Protocol (MMTP) over User Datagram Protocol (UDP) and Internet Protocol (IP) and Real-time Object delivery over Unidirectional Transport (ROUTE) over UDP and IP. MMTP is described in ISO/IEC: ISO/IEC 23008-1, “Information technologyHigh efficiency coding and media delivery in heterogeneous environments-Part 1: MPEG media transport (MMT).” An overview of ROUTE is provided in ATSC Candidate Standard: Signaling, Delivery, Synchronization, and Error Protection (A/331) Doc. 533-1-500r5, 14 Jan. 2016, Rev. 5 31 Mar. 2016 (hereinafter “A/331”), which is incorporated by reference in its entirety. It should be noted that although ATSC 3.0 uses the term broadcast in some contexts to refer to a unidirectional over-the-air transmission physical layer, the so-called ATSC 3.0 broadcast physical layer supports video delivery through streaming or file download. As such, the term broadcast as used herein should not be used to limit the manner in which video and associated data may be transported according to one or more techniques of this disclosure. Further, content delivery protocol model 100 supports signaling at the ATSC Broadcast Physical Layer (e.g., signaling using the physical frame preamble), at the ATSC Link-Layer (signaling using a Link Mapping Table (LMT)), at the IP layer (e.g., so-called Low Level Signaling (LLS)), service layer signaling (SLS) (e.g., signaling using messages in MMTP or ROUTE), and application or presentation layer signaling (e.g., signaling using a video or audio watermark).

In some examples, a receiver device receiving an emergency alert message may receive information corresponding to an emergency alert message. As described above, in the proposed ATSC 3.0 suite of standards, the physical layer includes a frame structure that includes a bootstrap, a preamble, and a data payload including one or more PLPs. A/321 defines a bootstrap including three symbols. In A/321, the first bootstrap symbol includes a first emergency alert wake up one bit field, ea_wake_up_1, and the second bootstrap symbol includes, a second emergency alert wake up one bit field, ea_wake_up_2. The proposed ATSC 3.0 suite of standards, the values of ea_wake_up_1 and ea_wake_up_2 are defined according to Table 1.

TABLE 1

| Value | Meaning |
|---|---|
| ‘00’ | No emergency to wake up devices is currently signaled |
| ‘01’ | Emergency to wake up devices - setting 1 |
| ‘10’ | Emergency to wake up devices - setting 2 |
| ‘11’ | Emergency to wake up devices - setting 3 |

Thus, each of ea_wake_up_1 and ea_wake_up_2 enable receiver devices to detect if emergency information is available (i.e., when either of ea_wake_up_1 and ea_wake_up_2 equal 1). Further, in Table 1, a change from one setting to another indicates a new wake up call. It should be noted that in the proposed ATSC 3.0 suite of standards there is no requirement to use ea_wake_up_1 and ea_wake_up_2. That is, a service provider may distribute an emergency alert message without using the emergency alert wake up bits. Further, with respect to the proposed ATSC 3.0 suite of standards, a setting is intended to be relatively static (i.e., change at a relatively low frequency, e.g., minutes or hours). For example, a change from one setting to another setting may occur if/when a winter storm watch emergency alert changes to a winter storm warning emergency alert.

As described above, the proposed ATSC 3.0 suite of standards supports signaling at the IP layer, which is referred to as Low Level Signaling (LLS). In the proposed ATSC 3.0 suite of standards, LLS includes signaling information which is carried in the payload of IP packets having an address/port dedicated to this signaling function. The proposed ATSC 3.0 suite of standards defines four types of LLS information that may be signaled in the form of a LLS Table: Service List Table (SLT), Rating Region Table (RRT), SystemTime fragment, and Common Alerting Protocol (CAP) message. Table 2 provides the syntax provided for an LLS table, as defined according to the proposed ATSC 3.0 suite of standards. In Table 2, and other tables described herein, uimsbf refers to an unsigned integer most significant bit first data format and var refers to a variable number of bits.

TABLE 2

| | No. of | |
|---|---|---|
| Syntax | Bits | Format |
| LLS_table( ) { | | |
| LLS_table_id | 8 | uimsbf |
| provider_id | 8 | uimsbf |
| LLS_table_version | 8 | uimsbf |
| switch (LLS_table_id) { | | |
| case 0x01: | | |
| SLT | var | Sec. 6.3 of A/331 |
| break; | | |
| case 0x02: | | |
| RRT | var | Annex F of A/331 |
| break; | | |
| case 0x03: | | |
| SystemTime | var | Sec. 6.4 of A/331 |
| break; | | |
| case 0x04: | | |
| CAP | var | Sec. 6.5 of A/331 |
| break; | | |
| default: | | |
| reserved | var | |
| } | | |
| } | | |

A/331 provides the following semantics for syntax elements included in Table 2:

LLS_table_id—An 8-bit unsigned integer that shall identify the type of table delivered in the body.

provider_id—An 8-bit unsigned integer that shall identify the provider that is associated with the services signaled in this instance of LLS_table( ), where a “provider” is a broadcaster that is using part or all of this broadcast stream to broadcast services. The provider_id shall be unique within this broadcast stream.

LLS_table_version—An 8-bit unsigned integer that shall be incremented by 1 whenever any data in the table identified by table_id changes. When the value reaches 0xFF, the value shall wrap to 0x00 upon incrementing.

SLT—The XML format Service List Table, compressed with gzip [i.e., the gzip file format].

RRT—An instance of a Rating Region Table conforming to the structure specified in Annex F [of A/331], compressed with gzip.

SystemTime—The XML format System Time fragment, compressed with gzip.

CAP—The XML format Common Alerting Protocol fragment compressed with gzip.

It should be noted that the proposed ATSC 3.0 suite of standards specifies that a Common Alerting Protocol fragment is formatted according to CAP Version 1.2. It should be noted that modifications to CAP Version 1.2 for inclusion in the ATSC 3.0 suite of standards are currently being proposed.

As described above, the proposed ATSC 3.0 suite of standards supports signaling using a video or audio watermark. A watermark may be useful to ensure that a receiver device can retrieve supplementary content (e.g., emergency messages, alternative audio tracks, application data, closed captioning data, etc.) regardless of how multimedia content is distributed. For example, a local network affiliate may embed a watermark in a video signal to ensure that a receiver device can retrieve supplemental information associated with a local television presentation (e.g., a local news broadcast) and thus, present supplemental content to a viewer. For example, a content provider may wish to ensure that the message appears with the presentation of a media service during a redistribution scenario. An example of a redistribution scenario may include a situation where an ATSC 3.0 receiver device receives a multimedia signal (e.g., a video and/or audio signal) and recovers embedded information from the multimedia signal. For example, a receiver device (e.g., a digital television) may receive an uncompressed video signal from a multimedia interface (e.g., a High Definition Multimedia Interface (HDMI), or the like) and the receiver device may recover embedded information from the uncompressed video signal. In some cases, a redistribution scenario may occur when a MVPD acts as an intermediary between a receiver device and a content provider (e.g., a local network affiliate). In these cases, a set-top box may receive a multimedia service data stream through particular physical, link, and/or network layers formats and output an uncompressed multimedia signal to a receiver device. It should be noted that in some examples, a redistribution scenario may include a situation where set-top box or a home media server acts as in-home video distributor and serves (e.g., through a local wired or wireless network) to connected devices (e.g., smartphones, tablets, etc.). Further, it should be noted that in some cases, an MVPD may embed a watermark in a video signal to enhance content originating from a content provider (e.g., provide a targeted supplemental advertisement).

ATSC Candidate Standard: Content Recovery (A/336), Doc. 533-178r2, 15 Jan. 2016 (hereinafter “A/336”), which is incorporated by reference in its entirety, specifies how certain signaling information can be carried in audio watermark payloads, video watermark payloads, and the user areas of audio tracks, and how this information can be used to access supplementary content in a redistribution scenario. A/336 describes where a video watermark payload may include emergency_alert_message( ). An emergency_alert_message( ) supports delivery of emergency alert information in video watermarks. Table 3 provides the syntax of an emergency_alert_message( ) as provided in A/336.

TABLE 3

| | No. of | |
|---|---|---|
| Syntax | Bits | Format |
| emergency_alert_message( ) { | | |
| CAP_message_ID_length (N1) | 8 | uimsbf |
| CAP_message_ID | 8 * (N1) | |
| CAP_message_url_length (N2) | 8 | uimsbf |
| CAP_message_url | 8 * (N2) | |
| expires | 32 | uimsbf |
| urgency | 1 | bslbf |
| severity_certainty | 4 | bslbf |
| reserved | 3 | “111” |
| } | | |

A/336 provides the following definitions for respective syntax elements

CAP_message_ID_length, CAP_message_ID, CAP_message_url_length, CAP_message_url, expires, urgency, severity_certainty. It should be noted that in Table 3 and other tables included bslbf may refer to bit string, left bit first.

CAP_message_ID_length—This 8-bit unsigned integer field gives the length of the CAP_message_ID field in bytes.

CAP_message_ID—This string shall give the ID of the CAP message defined in [CAP Version 1.2]. It shall be the value of the cap.alert.identifier element of the [Common Alerting Protocol (CAP)] message indicated by CAP_message_url.

CAP_message_url_length—This 8-bit unsigned integer field gives the length of the CAP_message_url field in bytes.

CAP_message_url—This string shall give the URL that can be used to retrieve the CAP message.

expires—This parameter shall indicate the latest expiration date and time of any <info> element in the CAP message, encoded as a 32-bit count of the number of seconds since Jan. 1, 1970 00:00:00, International Atomic Time (TAI). urgency—When set to ‘1’, this flag shall indicate that the urgency of the most

urgent <info> element in the CAP message is “Immediate.” When set to ‘0’, it shall indicate otherwise.

severity_certainty—This is a 4-bit field code that is derived from the values of the required CAP elements of certainty and severity.

In this manner, the proposed ATSC 3.0 suite of standards provides a mechanisms for retrieving a CAP XML fragment using a URL embedded in a watermark signal and/or retrieving a CAP XML fragment by parsing an LLS table and provides emergency alert wake up signaling using two one-bit fields in the preamble of a physical layer frame. The currently proposed ATSC 3.0 suite of standards does not provide a mechanism to signal whether an emergency alert message is directly integrated into the presentation of a multimedia content (e.g., whether video has an emergency alert message burned-in to the video as part of an onscreen emergency alert message). It should be noted that in some cases in order to ensure that an emergency alert message directly integrated into the presentation of a multimedia content is apparent to a user, it may be useful and/or necessary for a service provider to signal whether an emergency alert message is directly integrated into the presentation of a multimedia content. For example, a receiver device may be running an application that minimizes the size of a multimedia presentation (e.g., an electronic service guide application) or rendering an application based feature on a display that obscures an emergency alert message (e.g., a pop-up advertisement window at the bottom of a display that covers up scrolling text of an emergency alert). In such examples, it may be useful and/or necessary for a receiver device to temporally suspend applications and/or change how a multimedia presentation is rendered in order to increase the likelihood that a user is aware of the emergency alert message.

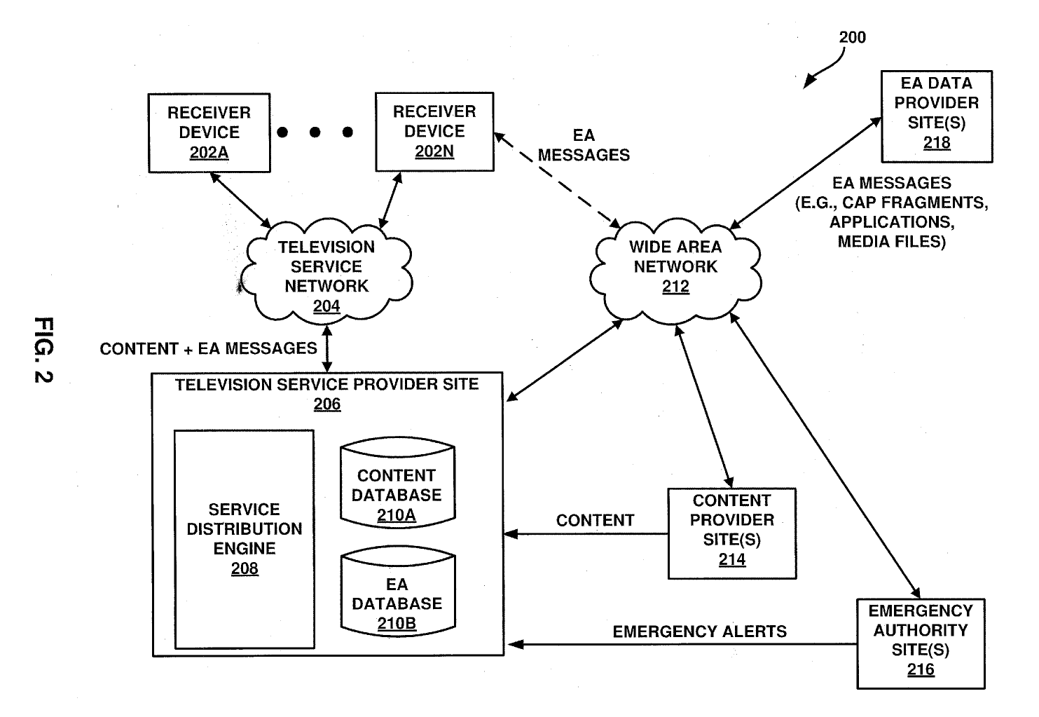

FIG. 2 is a block diagram illustrating an example of a system that may implement one or more techniques described in this disclosure. System 200 may be configured to communicate data in accordance with the techniques described herein. In the example illustrated in FIG. 2, system 200 includes one or more receiver devices 202A-202N, television service network 204, television service provider site 206, wide area network 212, one or more content provider site(s) 214, one or more emergency authority site(s) 216, and one or more emergency alert data provider site(s) 218. System 200 may include software modules. Software modules may be stored in a memory and executed by a processor. System 200 may include one or more processors and a plurality of internal and/or external memory devices. Examples of memory devices include file servers, file transfer protocol (FTP) servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 200 represents an example of a system that may be configured to allow digital media content, such as, for example, a movie, a live sporting event, etc., and data, applications and media presentations associated therewith (e.g., emergency messages alerts), to be distributed to and accessed by a plurality of computing devices, such as receiver devices 202A-202N. In the example illustrated in FIG. 2, receiver devices 202A-202N may include any device configured to receive data from television service provider site 206. For example, receiver devices 202A-202N may be equipped for wired and/or wireless communications and may be configured to receive services through one or more data channels and may include televisions, including so-called smart televisions, set top boxes, and digital video recorders. Further, receiver devices 202A-202N may include desktop, laptop, or tablet computers, gaming consoles, mobile devices, including, for example, “smart” phones, cellular telephones, and personal gaming devices configured to receive data from television service provider site 206. It should be noted that although system 200 is illustrated as having distinct sites, such an illustration is for descriptive purposes and does not limit system 200 to a particular physical architecture. Functions of system 200 and sites included therein may be realized using any combination of hardware, firmware and/or software implementations.

Television service network 204 is an example of a network configured to enable digital media content, which may include television services, to be distributed. For example, television service network 204 may include public over-the-air television networks, public or subscription-based satellite television service provider networks, and public or subscription-based cable television provider networks and/or over the top or Internet service providers. It should be noted that although in some examples television service network 204 may primarily be used to enable television services to be provided, television service network 204 may also enable other types of data and services to be provided according to any combination of the telecommunication protocols described herein. Further, it should be noted that in some examples, television service network 204 may enable two-way communications between television service provider site 206 and one or more of receiver devices 202A-202N. Television service network 204 may comprise any combination of wireless and/or wired communication media. Television service network 204 may include coaxial cables, fiber optic cables, twisted pair cables, wireless transmitters and receivers, routers, switches, repeaters, base stations, or any other equipment that may be useful to facilitate communications between various devices and sites. Television service network 204 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 2, television service provider site 206 may be configured to distribute television service via television service network 204. For example, television service provider site 206 may include one or more broadcast stations, an MVPD, such as, for example, a cable television provider, or a satellite television provider, or an Internet-based television provider. In the example illustrated in FIG. 2, television service provider site 206 includes service distribution engine 208, content database 210A, and emergency alert database 210B. Service distribution engine 208 may be configured to receive data, including, for example, multimedia content, interactive applications, and messages, including emergency alerts and/or emergency alert messages, and distribute data to receiver devices 202A-202N through television service network 204. For example, service distribution engine 208 may be configured to transmit television services according to aspects of the one or more of the transmission standards described above (e.g., an ATSC standard). In one example, service distribution engine 208 may be configured to receive data through one or more sources. For example, television service provider site 206 may be configured to receive a transmission including television programming from a regional or national broadcast network (e.g., NBC, ABC, etc.) through a satellite uplink/downlink or through a direct transmission. Further, as illustrated in FIG. 2, television service provider site 206 may be in communication with wide area network 212 and may be configured to receive multimedia content and data from content provider site(s) 214. It should be noted that in some examples, television service provider site 206 may include a television studio and content may originate therefrom.

Content database 210A and emergency alert database 210B may include storage devices configured to store data. For example, content database 210A may store multimedia content and data associated therewith, including for example, descriptive data and executable interactive applications. For example, a sporting event may be associated with an interactive application that provides statistical updates. Emergency alert database 210B may store data associated with emergency alerts, including, for example, emergency alert messages. Data may be formatted according to a defined data format, such as, for example, HTML, Dynamic HTML, XML, and JavaScript Object Notation (JSON), and may include URLs and URIs enabling receiver devices 202A-202N to access data, e.g., from one of emergency alert data provider site(s) 218. In some examples, television service provider site 206 may be configured to provide access to stored multimedia content and distribute multimedia content to one or more of receiver devices 202A-202N through television service network 204. For example, multimedia content (e.g., music, movies, and television (TV) shows) stored in content database 210A may be provided to a user via television service network 204 on a so-called on demand basis.

Wide area network 212 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 212 may comprise any combination of wireless and/or wired communication media. Wide area network 212 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 212 may include the Internet.

Referring again to FIG. 2, content provider site(s) 214 represent examples of sites that may provide multimedia content to television service provider site 206 and/or in some cases to receiver devices 202A-202N. For example, a content provider site may include a studio having one or more studio content servers configured to provide multimedia files and/or content feeds to television service provider site 206. In one example, content provider site(s) 214 may be configured to provide multimedia content using the IP suite. For example, a content provider site may be configured to provide multimedia content to a receiver device according to Real Time Streaming Protocol (RTSP), HyperText Transfer Protocol (HTTP), or the like.

Emergency authority site(s) 216 represent examples of sites that may provide emergency alerts to television service provider site 206. For example, as described above, emergency authorities may include the United States National Weather Service, the United States Department of Homeland Security, local and regional agencies, and the like. An emergency authority site may be a physical location of an emergency authority in communication (either directly or through wide area network 212) television service provider site 206. An emergency authority site may include one or more servers configured to provide emergency alerts to television service provider site 206. As described above, a service provider, e.g., television service provider site 206, may receive an emergency alert and generate an emergency alert message for distribution to a receiver device, e.g., receiver devices 202A-202N. It should be noted that in some cases an emergency alert and an emergency alert message may be similar. For example, television service provider site 206 may pass through an XML fragment received from emergency authority site(s) 216 to receiver devices 202A-202N as part of an emergency alert message. Television service provider site 206 may generate an emergency alert message according to a defined data format, such as, for example, HTML, Dynamic HTML, XML, and JSON.

As described above, an emergency alert message may include URLs that identify where additional information related to the emergency may be obtained. Emergency alert data provider site(s) 218 represent examples of sites configured to provide emergency alert data, including hypertext based content, XML fragments, and the like, to one or more of receiver devices 202A-202N and/or, in some examples, television service provider site 206 through wide area network 212. Emergency alert data provider site(s) 218 may include one or more web servers. It should be noted that data provided by emergency alert data provider site(s) 218 may include audio and video content.

As described above, service distribution engine 208 may be configured to receive data, including, for example, multimedia content, interactive applications, and messages, and distribute data to receiver devices 202A-202N through television service network 204. Thus, in one example scenario, television service provider site 206 may receive an emergency alert from emergency authority site(s) 216 (e.g., terrorist warning). Service distribution engine 208 may generate an emergency alert message (e.g., an onscreen “terrorist warning” scrolling text) based on the emergency alert, cause the emergency message to be directly integrated into content received from a content provider site(s) 214, and generate a signal including the content with the integrated emergency alert message. For example, service distribution engine 208 may burn-in an emergency alert message into television programming (e.g., an on-screen emergency alert message) received from a network affiliate and generate a signal including the emergency alert message and television programming for reception by receiver devices 202A-202N.

FIG. 3 is a block diagram illustrating an example of a service distribution engine that may implement one or more techniques of this disclosure. Service distribution engine 300 may be configured to receive data and output a signal representing that data for distribution over a communication network, e.g., television service network 204. For example, service distribution engine 300 may be configured to receive one or more sets of data and output a signal that may be transmitted using a single radio frequency band (e.g., a 6 MHz channel, an 8 MHz channel, etc.) or a bonded channel (e.g., two separate 6 MHz channels).

As illustrated in FIG. 3, service distribution engine 300 includes component encapsulator 302, transport and network packet generator 304, link layer packet generator 306, frame builder and waveform generator 308, and system memory 310. Each of component encapsulator 302, transport and network packet generator 304, link layer packet generator 306, frame builder and waveform generator 308, and system memory 310 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although service distribution engine 300 is illustrated as having distinct functional blocks, such an illustration is for descriptive purposes and does not limit service distribution engine 300 to a particular hardware architecture. Functions of service distribution engine 300 may be realized using any combination of hardware, firmware and/or software implementations.

System memory 310 may be described as a non-transitory or tangible computer-readable storage medium. In some examples, system memory 310 may provide temporary and/or long-term storage. In some examples, system memory 310 or portions thereof may be described as non-volatile memory and in other examples portions of system memory 310 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. System memory 310 may be configured to store information that may be used by service distribution engine 300 during operation. It should be noted that system memory 310 may include individual memory elements included within each of component encapsulator 302, transport/network packet generator 304, link layer packet generator 306, and frame builder and waveform generator 308. For example, system memory 310 may include one or more buffers (e.g., First-in First-out (FIFO) buffers) configured to store data for processing by a component of service distribution engine 300.

Component encapsulator 302 may be configured to receive one or more components of a service and encapsulate the one or more components according to a defined data structure. For example, component encapsulator 302 may be configured to receive one or more media components and generate a package based on MMTP. Further, component encapsulator 302 may be configured to receive one or more media components and generate media presentation based on Dynamic Adaptive Streaming Over HTTP (DASH). Further, component encapsulator 302 may be configured to receive a video component an emergency alert and directly integrate an emergency alert message into the video component. In one example, component encapsulator 302 may directly integrate an emergency alert message into a video component by using video editing techniques (e.g., text overlay video editing techniques). Further, it should be noted that in some examples, component encapsulator 302 may directly integrate an emergency alert message into a video component by integrating data into encoded video data. For example, in the case where video data is encoded using HEVC component encapsulator 302 may directly integrate an emergency alert message into a video component by replacing one or more slices or tiles (e.g., a slice corresponding to the bottom of a picture or frame) with one or more slices or tiles including an emergency alert message. It should be noted that in this case, in may be necessary to ensure that replaced slices and/or tiles do not serve as a reference for other parts of encoded video data (e.g., used for motion compensation for subsequent frames). It should be that information regarding whether slices and/or tiles serve as a reference for other parts of encoded video data may be signaled using one or more messages provided in HEVC (e.g., a supplemental enhancement information (SEI) message). In this manner, component encapsulator 302 may be configured to include a crawl in a frame of encoded video data without completely decoding the encoded video data. Thus, the techniques described herein may be generally applicable to an emergency alert message being incorporated into a video presentation. It should be noted that in some examples, component encapsulator 302 may be configured to generate service layer signaling data.

Transport and network packet generator 304 may be configured to receive a transport package and encapsulate the transport package into corresponding transport layer packets (e.g., UDP, Transport Control Protocol (TCP), etc.) and network layer packets (e.g., IPv4, IPv6, compressed IP packets, etc.). In one example, transport and network packet generator 304 may be configured to generate signaling information that is carried in the payload of IP packets having an address/port dedicated to signaling function. That is, for example, transport and network packet generator 304 may be configured to generate LLS tables according to one or more techniques of this disclosure.

Link layer packet generator 306 may be configured to receive network packets and generate packets according to a defined link layer packet structure (e.g., an ATSC 3.0 link layer packet structure). Frame builder and waveform generator 308 may be configured to receive one or more link layer packets and output symbols (e.g., OFDM symbols) arranged in a frame structure. As described above, a frame may include one or more PLPs may be referred to as a physical layer frame (PHY-Layer frame). As described above, a frame structure may include a bootstrap, a preamble, and a data payload including one or more PLPs. A bootstrap may act as a universal entry point for a waveform. A preamble may include so-called Layer-1 signaling (L1-signaling). L1-signaling may provide the necessary information to configure physical layer parameters. Frame builder and waveform generator 308 may be configured to produce a signal for transmission within one or more of types of RF channels: a single 6 MHz channel, a single 7 MHz channel, single 8 MHz channel, a single 11 MHz channel, and bonded channels including any two or more separate single channels (e.g., a 14 MHz channel including a 6 MHz channel and a 8 MHz channel). Frame builder and waveform generator 308 may be configured to insert pilots and reserved tones for channel estimation and/or synchronization. In one example, pilots and reserved tones may be defined according to an Orthogonal Frequency Division Multiplexing (OFDM) symbol and sub-carrier frequency map. Frame builder and waveform generator 308 may be configured to generate an OFDM waveform by mapping OFDM symbols to sub-carriers. It should be noted that in some examples, frame builder and waveform generator 308 may be configured to support layer division multiplexing. Layer division multiplexing may refer to super-imposing multiple layers of data on the same RF channel (e.g., a 6 MHz channel). Typically, an upper layer refers to a core (e.g., more robust) layer supporting a primary service and a lower layer refers to a high data rate layer supporting enhanced services. For example, an upper layer could support basic High Definition video content and a lower layer could support enhanced Ultra-High Definition video content.

As described above, transport and network packet generator 304 may be configured to generate LLS tables according to one or more techniques of this disclosure. It should be noted that in some examples, a service distribution engine (e.g., service distribution engine 208 or service distribution engine 300) or specific components thereof may be configured to generate signaling messages according to the techniques described herein. As such, description of signaling messages, including data fragments, with respect to transport and network packet generator 304 should not be construed to limit the techniques described herein. As described above, it may be useful and/or necessary for a receiver device to temporally suspend applications and/or change how a multimedia presentation is rendered in order to increase the likelihood that a user is aware of the emergency alert message. As described above, currently proposed techniques for signaling information associated with emergency alert messages may be less than ideal for enabling a receiver device to temporally suspend applications and/or change how a multimedia presentation is rendered in response to an emergency alert message. In particular, embedding a Boolean flag in the CAP XML fragment in order to indicate that an emergency alert message is directly integrated into multimedia content may be less than ideal. For example, with respect to the currently proposed techniques, once the Boolean flag is set to true, a second CAP XML fragment is required to set the flag to false to “switch off” the emergency alert message notification. This may be problematic, because a receiver device in a poor reception area may not be able to receive a subsequent CAP XML fragment with a reasonable degree of certainty. A receiver device not receiving the second message CAP XML setting the flag to false may become “stuck” in a state indicating that an emergency alert message is directly integrated into multimedia content and as such may continue to unnecessarily suspend an application or render a multimedia presentation in order to increase the likelihood that a user is aware of the emergency alert message.

Transport and network packet generator 304 may be configured to signal to the receiver devices that an emergency alert message is directly integrated into multimedia content in an effective and efficient manner. In one example, transport and network packet generator 304 may be configured to generate an LLS table based on the example syntax provided in Table 4A. In the example illustrated in Table 4A, a separate entry EmergencyOnscreenNotification is included in an LLS table.

TABLE 4A

| | No. of | |
|---|---|---|
| Syntax | Bits | Format |
| LLS_table( ) { | | |
| LLS_table_id | 8 | uimsbf |
| provider_id | 8 | uimsbf |
| LLS_table_version | 8 | uimsbf |
| switch (LLS_table_id) { | | |
| case 0x01: | | |
| SLT | var | Sec. 6.3 of |
| | | A/331 |
| break; | | |
| case 0x02: | | |
| RRT | var | See Annex F |
| | | of A/331 |
| break; | | |
| case 0x03: | | |
| SystemTime | var | Sec. 6.4 of |
| | | A/331 |
| break; | | |
| case 0x04: | | |
| CAP | var | Sec. 6.5 of |
| | | A/331 or |
| | | alternatives |
| | | described |
| | | below |
| break; | | |
| case 0x05: | | |
| EmergencyOnscreenNotification | var | |
| break; | | |
| default: | | |
| reserved | var | |
| } | | |
| } | | |

In the example illustrated in Table 4A, each of LLS_table_id, provider_id, LLS_table_version, SLT, RRT, SystemTime, and CAP may be based on the semantics provided above with respect to Table 2. However, it should be noted that in some examples, CAP may be based on the examples described below. Additionally, in one example, syntax element EmergencyOnscreenNotification may include an XML format Emergency On Screen Notification compressed with gzip.

As described above, the techniques described herein may be generally applicable to any type of messaging that a service provider integrates in to a multimedia presentation. In one example, transport and network packet generator 304 may be configured to generate an LLS table based on the example syntax provided in Table 4B. In the example illustrated in Table 4B, a separate entry OnscreenMessageNotification is included in an LLS table.

TABLE 4B

| Syntax | No. of Bits | Format |
|---|---|---|
| LLS_table( ) { | | |
| LLS_table_id | 8 | uimsbf |
| provider_id | 8 | uimsbf |
| LLS_table_version | 8 | uimsbf |
| switch (LLS_table_id) { | | |
| case 0x01: | | |
| SLT | var | Sec. 6.3 of |
| | | A/331 |
| break; | | |
| case 0x02: | | |
| RRT | var | See Annex F |
| | | of A/331 |
| break; | | |
| case 0x03: | | |
| SystemTime | var | Sec. 6.4 of |
| | | A/331 |
| break; | | |
| case 0x04: | | |
| CAP | var | Sec. 6.5 of |
| | | A/331 or |
| | | alternatives |
| | | described |
| | | below |
| break; | | |
| case 0x05: | | |
| OnscreenMessageNotification | var | |
| break; | | |
| default: | | |
| reserved | var | |
| } | | |
| } | | |

In the example illustrated in Table 4B, each of LLS_table_id, provider_id, LLS_table_version, SLT, RRT, SystemTime, and CAP may be based on the semantics provided above with respect to Table 2. However, it should be noted that in some examples, CAP may be based on the examples described below. Additionally, in one example, syntax element OnscreenMessageNotification may include an XML format On Screen message Notification compressed with gzip.

Referring to Table 4A, in one example, EmergencyOnscreenNotification may include the attributes illustrated in Table 5. It should be noted that in Table 5, and other tables included herein, data types unsignedShort, dateTime, and duration may correspond to definitions provided in XML Schema Definition (XSD) recommendations maintained by the World Wide Web Consortium (W3C). Further, use may correspond to cardinality of an element or attribute (i.e., the number of occurrences of the element or attribute).

TABLE 5

| Element or Attribute Name | Use | Data Type | Description |
|---|---|---|---|
| EmergencyOnscreenNotification | 1 | | |
| @bsid | 1 | unsignedShort | Identifier of the |
| | | | broadcast stream. |
| @serviceID | 0 . . . 1 | unsignedShort | Identifier of the |
| | | | service within the |
| | | | scope of the broadcast |
| | | | stream that the |
| | | | notification applies. |
| @serviceIDrange | 0 . . . 1 | unsignedShort | Identifier of a range |
| | | | of serviceID that this |
| | | | notification applies. |
| @start | 0 . . . 1 | dateTime | Indicates the date and |
| | | | time that the |
| | | | notification starts. |
| @duration | 1 | Duration | Indicates the duration |
| | | | of the notification. |

In one example, @bsid, @serviceID, @serviceIDrange, @start, and @duration may be based on the following semantics:

@bsid—specifies the identifier of broadcaster stream

@ serviceID—specifies the unique identifier for a service within the scope of the broadcast stream. When @ serviceID is not present, the EmergencyOnscreenNotification applies to all services in the broadcast stream identified by @bsid.

@ serviceIDrange—specifies the range of services within the scope of the broadcast stream. @serviceIDrange can only be present when @ serviceID is present. When @serviceID is present and @ serviceIDrange is not present, it is inferred to have the value 0. When @ serviceIDrange is present, the EmergencyOnscreenNotification applies to the services identified by the identifier numbers ranging from @ serviceID to @ServiceID+@serviceIDrange in the broadcast stream identified by @bsid.

@ start—when present, specifies the date time information when on-screen emergency event begins. When @ start is not present, it is inferred to be the current time.

@ duration—specifies the duration of time starting at @ start or current time if @ start is not present, for which the on screen emergency event is valid. @duration of value of “PT0” is reserved to signal Cancellation of the EmergencyOnscreenNotification.

In this manner, attributes @bsid, @ serviceID, @ serviceIDrange, @ start, and @duration may be used by a service provider to signal a notification of emergency on-screen information, e.g., burnt-in crawl text and/or graphics corresponding to an emergency alert message. It should be noted that signaling attributes @bsid, @ serviceID, @ serviceIDrange, @ start, and @ duration may be more suitable to a terrestrial broadcast system that is subject to varying degree of signal strength across its service area than signaling Boolean flags in a CAP XML fragment. For example, a receiver device may determine that an emergency alert message is not onscreen upon the value of duration expiring and resume normal operation. Further, it should be noted that the degree that signaling strength varies across a service area may be particularly significant during a weather-related or geological emergency.

Further, it should be noted that signaling the identifier of a broadcast stream and identifier of a service that includes an emergency alert message is directly integrated into multimedia content enables a service provider to signal indications of a serviceby-service basis. For example, a broadcaster may provide two video streams to receiver devices (e.g., using channel 5-1 and channel 5-2), and at a specific moment, only one of the video streams may include a burn-in of an emergency alert message. In this case, using the example syntax provided in Table 4A and Table 5, the broadcaster can signal which video includes a burn-in message. Further, using the example syntax provided in Table 4A and Table 5, a service provider may be enabled to choose on a service-by-service basis whether a notification of relatively low priority emergency alert message (e.g., school closures) should be signaled and thus, potential affect the operation of a receiver device. Further, it should be noted that in some examples, @ serviceIDrange may be intended to be used when multiple service providers are sharing the same LLS Table. In this case, each service provider may be expected to have a range of service IDs that are contiguous and non-overlap.

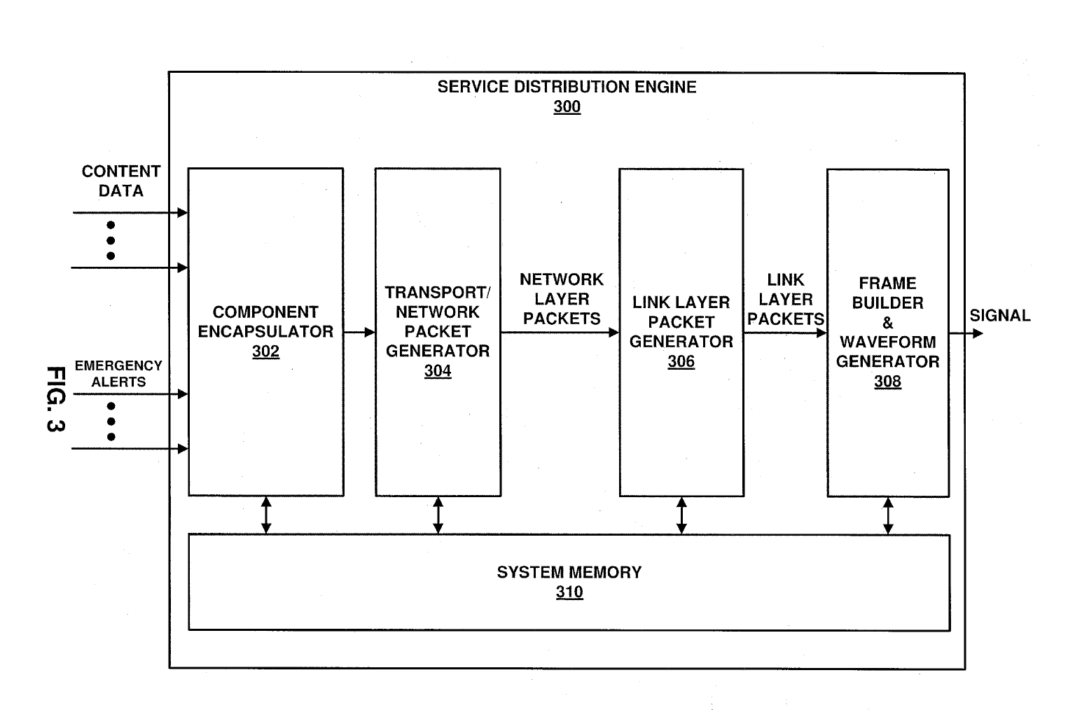

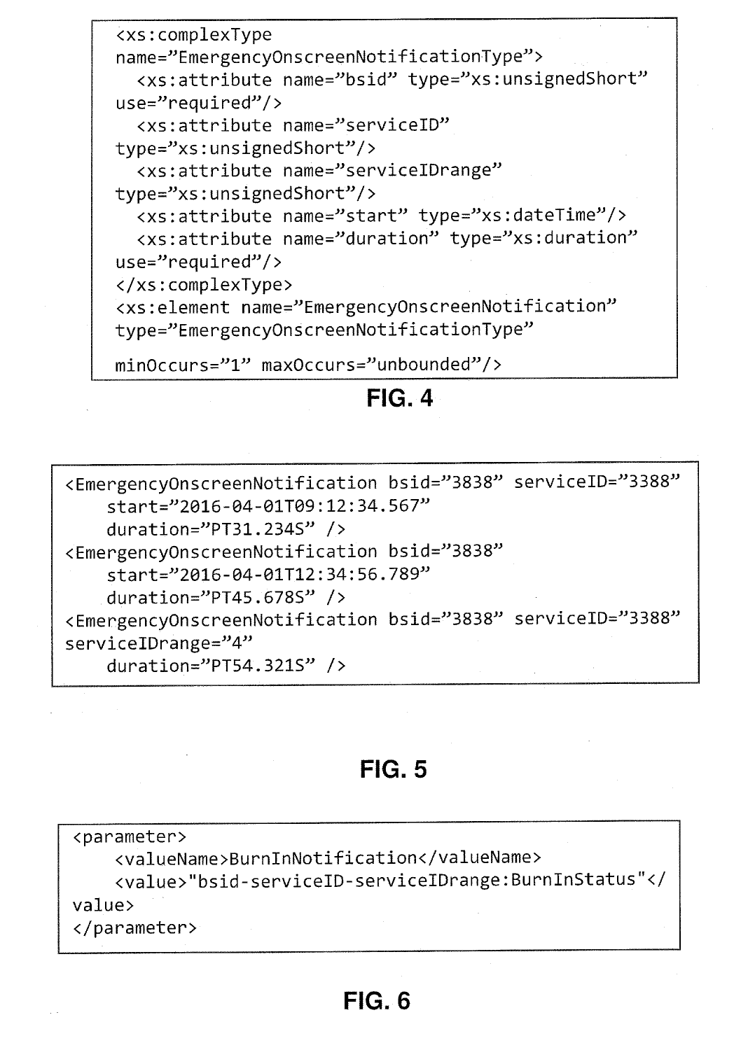

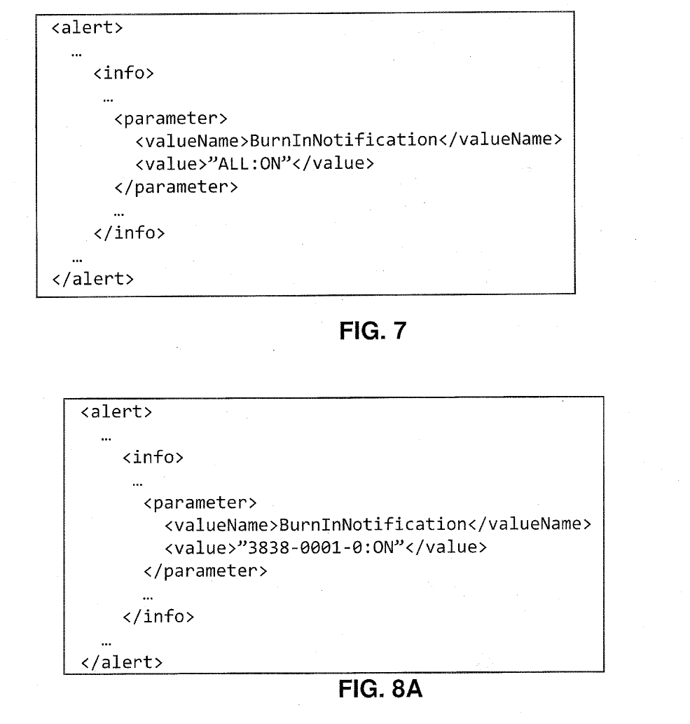

FIG. 4 is a computer program listing illustrated an example of an emergency communication message formatted according to a schema according to one or more techniques of this disclosure. In the example illustrated in FIG. 4, the example XML schema is based on the example illustrated in Tables 4A and Table 5. FIG. 5 is a computer program listing illustrating an example of emergency communication messages formatted according to a schema according to one or more techniques of this disclosure. In the example illustrated in FIG. 5, examples of messages based on the schema illustrated in Table 4A and Table 5 are provided. In particular, in the example illustrated in FIG. 5, a first notification of an emergency alert message directly integrated into a media component of a service (i.e., EmergencyOnscreenNotification), starts at Apr. 1, 2016, 9:12:34.567 and has a duration of 31.234 seconds for one service, and second EmergencyOnscreenNotification starts at Apr. 1, 2016, 12:34:56.789 and has a duration 45.678 seconds for all services and a third EmergencyOnscreenNotification applies to a range of services, starting at current time, with a duration of 54.321 seconds.

It should be noted that in other examples, EmergencyOnscreenNotification may include additional attributes and/or elements and any combination of the addition attributes and/or elements and the example attributes described above with respect to Table 5 may be included in an EmergencyOnscreenNotification schema. In some examples, EmergencyOnscreenNotification may include the EmergencyOnscreenNotification element illustrated in Table 6.

TABLE 6

| Element or Attribute Name | Use | Data Type | Description |
|---|---|---|---|
| EmergencyOnscreenNotification | 1 | boolean | Indicates the TRUE or FALSE |
| | | | state corresponding to the ON or |
| | | | OFF state of the |
| | | | EmergencyOnscreenNotification |

In one example, EmergencyOnscreenNotification element as illustrated in Table 6 may be based on the following semantics:

EmergencyOnscreenNotification element is a Boolean flag used to indicate the TRUE (ON) or FALSE (OFF) state of the emergency on-screen notification.

In one example, multiple instances of EmergencyOnscreenNotification may be signaled. In such a case, each EmergencyOnscreenNotification may include a unique identifier for each instance (e.g., as an attribute or element). Any subsequent signaling (e.g., canceling an EmergencyOnscreenNotification) may reference the instance of the EmergencyOnscreenNotification using the unique identifier. It should be noted that in some examples, in addition to or as an alternative to the techniques described above with respect to Tables 4A-6, in some examples it may be useful for a service provider to signal information provided by @bsid, @serviceID, @start, and @duration using a CAP XML fragment. For example, EmergencyOnscreenNotification as illustrated in Table 6 may be included in an LLS table and corresponding identifiers of a broadcast stream and services and/or time and duration information may be included in a CAP XML fragment. In one example, the parameter in CAP Version 1.2 may be used to carry bsID and serviceID to signal specific services within a particular broadcast stream. FIG. 6 illustrates an example of a computer program listing illustrating where a parameter is used to indicate an identifier of a broadcast stream and identifiers of one or more services. It should be noted that in some examples, instead or signaling a pair of numbers indicating a bsid-serviceID pair, a character string (e.g., “ALL”) may be signaled to indicate that EmergencyOnscreenNotification applies to all services within the broadcast stream that the LLS is associated with.

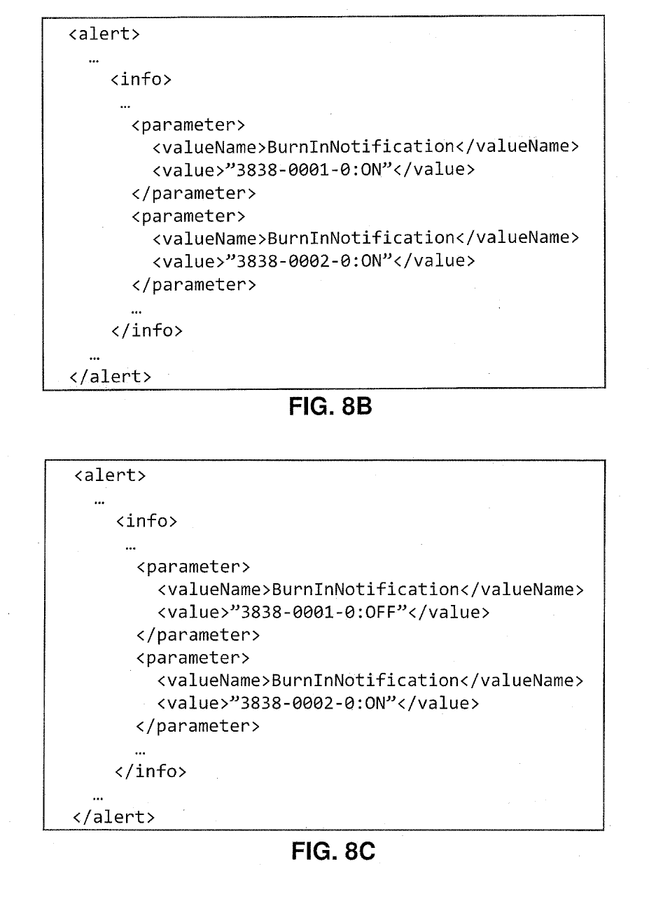

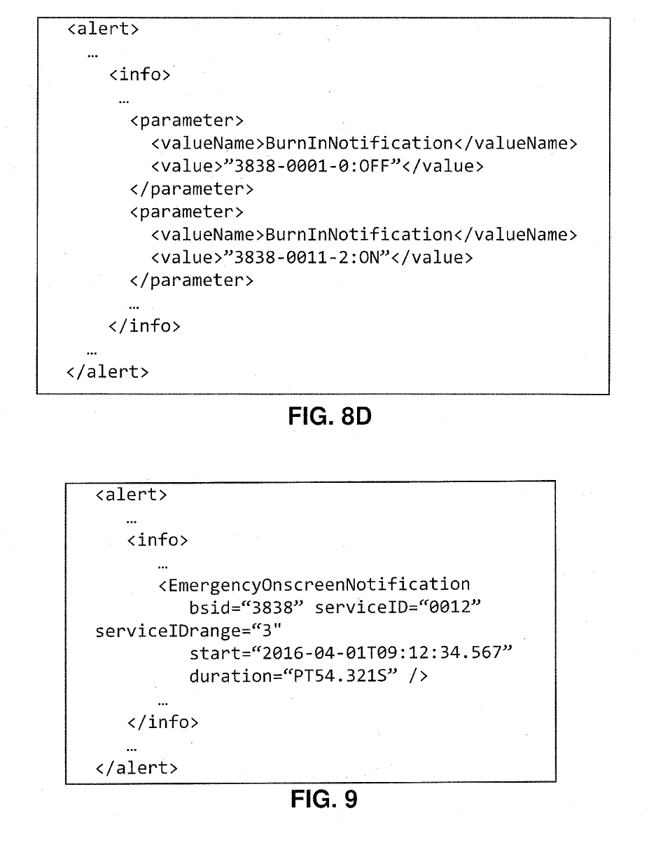

FIGS. 8A-8D illustrate examples where the parameter of CAP XML fragments are used to indicate whether an emergency alert message is directly integrated into multimedia content of a service (i.e., whether Burn-In turned ON for a service). In the example illustrated in FIG. 8A, the CAP XML fragment indicates that service 0001 with bsid 3838 has Burn-In turned ON. In the example illustrated in FIG. 8B, the CAP XML fragment indicates service 0001 and service 0002 in bsid 3838 have Burn-In turned ON. For example, service 0001 may have burn-in started previously, and continues, while service 0002 is starting burn-in. In the example illustrated in FIG. 8C, the CAP XML fragment indicates that service 0001 in bsid 3838 has Burn-In turned OFF and service 0002 in bsid 3838 has Burn-In turned ON. FIG. 8D represents an illustrative example where two service providers provide services using a channel sharing arrangement. In the example illustrated in FIG. 8D, service provider A has services 0001-0004 and service provider B has services 0010-0013 in bsid 3838 and the CAP XML fragment indicates that Burn-In is turned OFF for service 0001 and Burn-In is turned ON for all services 0011 and 0013. It should be noted that in some examples, instead on signaling an ON or OFF value for BurnlnNotification, the presence of BurnlnNotification may indicate that a service includes an emergency onscreen notification. Further, in a similar manner, in one example, the of other attributes or elements may indicate an emergency onscreen notification (e.g., the presence of a service identifier may indicate an emergency onscreen notification for the service).

In one example, CAP Version 1.2 may be modified to include @bsid and @serviceID attributes. In one example, a complex element

@EmergencyOnscreenNotification with @bsid, @serviceID, @duration, and optionally @ start may be defined for a CAP XML fragment. It should be noted that in this case, the on/off state served by a Boolean flag is implicit in the non-zero value of the attribute @duration. FIG. 9 is a computer program listing illustrating an example of a message generated according to a CAP XML schema including @EmergencyOnscreenNotification with @bsid, @serviceID, @duration, and optionally @start. In one example, each of @EmergencyOnscreenNotification, @bsid, @serviceID, @duration, and @start may be based on the following example semantics:

EmergencyOnscreenNotification element contains a broadcaster, service, and timing information of the on-screen emergency information.

@bsid—specifies the identifier of broadcaster stream.

@ serviceID—specifies the unique identifier for a service within the scope of the broadcast stream. When @ serviceID is not present, the EmergencyOnscreenNotification applies to all services in the broadcast stream identified by @bsid.

@ serviceIDrange—specifies the range of services within the scope of the broadcast stream. @serviceIDrange can only be present when @ serviceID is present. When @serviceID is present and @ serviceIDrange is not present, the it is inferred to have the value 0. When @ serviceIDrange is present, the EmergencyOnscreenNotification applies to the services identified by the identifier numbers ranging from @ serviceID to @serviceID+@serviceIDrange in the broadcast stream identified by @bsid. @ start—when present, specifies the date time information when on-screen emergency event begins. When @ start is not present, it is inferred to be equal the current time. In an example, current time is the time when a receiver receives the signaling corresponding to EmergencyOnscreenNotification.

@ duration—specifies the duration of time starting at @ start or current time if @ start is not present, for which the on screen emergency event is valid. In an example, @duration of value of “PT0” is reserved to signal Cancellation of the EmergencyOnscreenNotification.

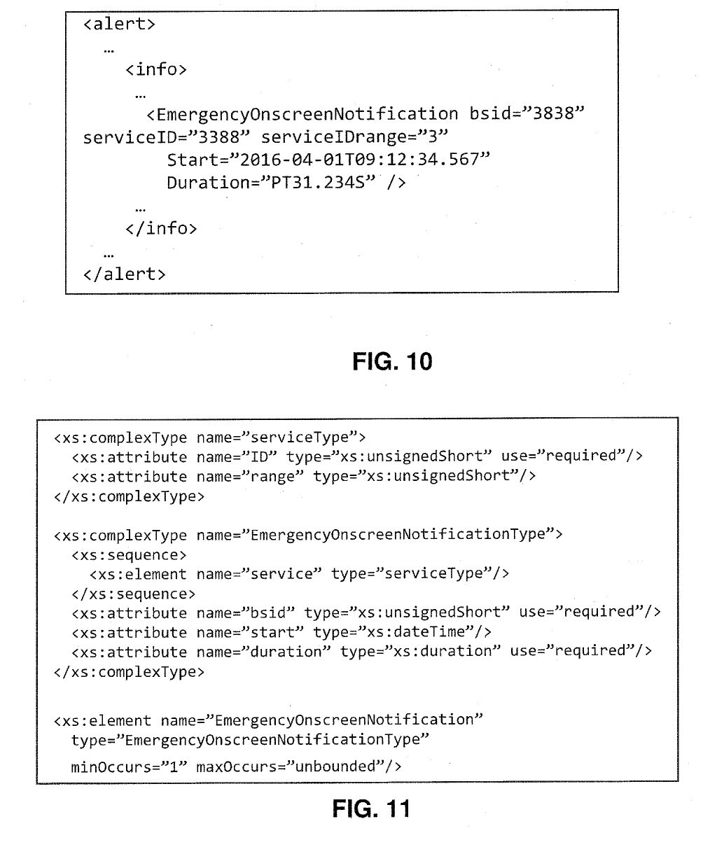

FIG. 10 is a computer program listing illustrating an example of emergency communication messages formatted according to a schema illustrated in FIG. 9. In the example illustrated in FIG. 10 for services 3388 through 3391 in broadcaster stream 3838 an emergency on screen notification starts at Apr. 1, 2016, 12:34:56.7 and has a duration 31.234 seconds.

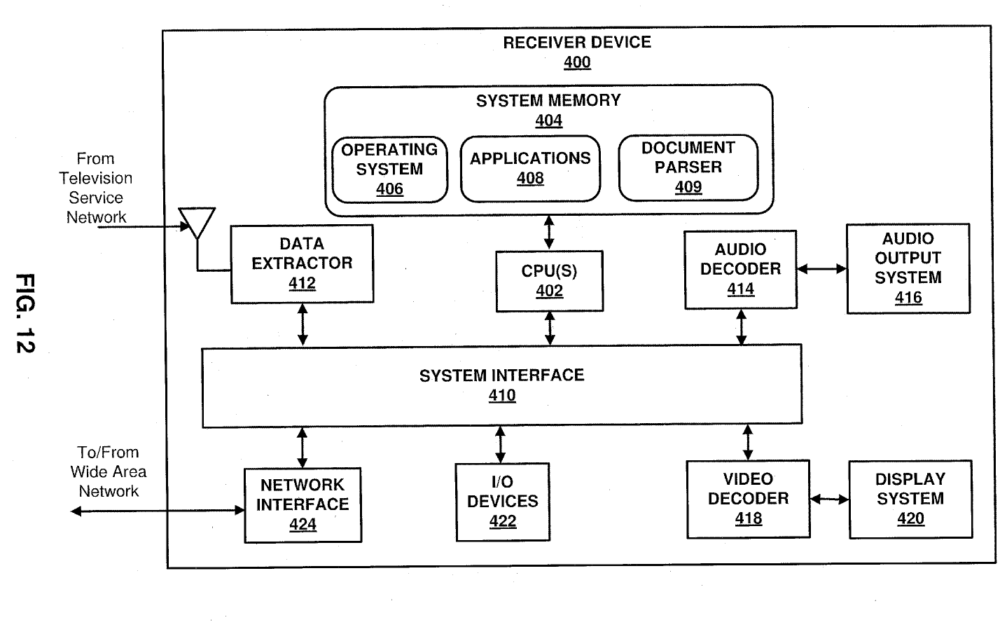

In one example, the schema illustrated in FIG. 11 may be used to indicate that an emergency alert message is directly integrated into multimedia content of service. As illustrated in FIG. 11, the example schema includes an XML element service which is of xs:complexType. In one example, service may have a required attribute of service@ID and an optional attribute of service@range. In this manner, the example schema illustrated in FIG. 11 constrains the use of service@ID and service@range, which may provide for more effective signaling in some instances. In this manner, service distribution engine 208 represents an example of a device configured to signaling information associated with an emergency alert message associated with a service according to one or more techniques of this disclosure.

Referring to Table 4B, in one example, OnscreenMessageNotification may include the elements and attributes illustrated in Table 7. It should be noted that the OnscreenMessageNotification is one of the instance types of LLS information. As illustrated in Table 7, OnscreenMessageNofication provides service information for on-screen important text/visual information, which may include emergency-related information, that has been rendered by broadcasters on their video service(s). It should be noted that the techniques described herein are generally applicable regardless of nomenclature used for elements and attributes in a particular implementation. For example, KeepScreenClear element and KSCFlag attribute in Table 7 could use nomenclature to express behavior with respect to a receiver device perspective instead of from an emitter (e.g., service provider) perspective. For example, KeepScreenClear may in some examples be implemented as MessageNotification, OnscreenNotification or MessageStatus, or the like, and KSCFlag could be implemented as MessagePresent, OnScreenPresent, PresentFlag, Status, Flag, or the like.

TABLE 7

| Element or Attribute Name | Use | Data Type | Description |
|---|---|---|---|
| OnscreenMessageNotification | 1 | | |
| KeepScreenClear | 0 . . . N | | Service Information |
| | | | related to Onscreen |
| | | | Message Notification |
| @bsid | 1 | unsignedShort | Identifier of the |
| | | | broadcast stream. |
| @serviceID | 0 . . . 1 | unsignedShort | Identifier of the |
| | | | service within the |
| | | | scope of the broadcast |
| | | | stream that the |
| | | | notification applies. |
| @serviceIDrange | 0 . . . 1 | unsignedShort | Identifier of a range |
| | | | of serviceID that this |
| | | | notification applies. |
| @KSCflag | 0 . . . 1 | boolean | Indicates the status of |
| | | | KeepScreenClear |

In one example, OnscreenMessageNotification, KeepScreenClear, @bsid, @ serviceID, @ serviceIDrange, and @KSCflag in Table 7 may be based on the following semantics:

OnscreenMessageNotification—root element contains broadcaster and service for onscreen important text/visual information, including emergency-related, information that has been rendered by broadcasters on their video service(s).

KeepScreenClear—Service Information related to the OnscreenMessageNotification.

@bsid—Identifier of the whole Broadcast Stream. The value of bsid shall be unique on a regional level (for example, North America). An administrative or regulatory authority may play a role.

@serviceID—16-bit integer that shall uniquely identify this Service within the scope of this Broadcast area. If not present, the KeepScreenClear is inferred to apply to all services within the broadcast stream identified by @bsid.

@serviceIDrange—specifies the range of services within the scope of the broadcast stream. @ serviceIDrange shall not be present when @ serviceID is not present. When @ serviceID is present and @ serviceIDrange is not present, the service ID range is inferred to have the value 0. When @ serviceIDrange is present, the KeepScreenClear applies to the services identified by the identifier numbers starting from @ serviceID to @ServiceID+@serviceIDrange in the broadcast stream identified by @bsid.

@KSCflag—indicates the status of the KeepScreenClear for the identified services within the identified broadcast stream. If not present, @ KSCflag is inferred to have the value FALSE.

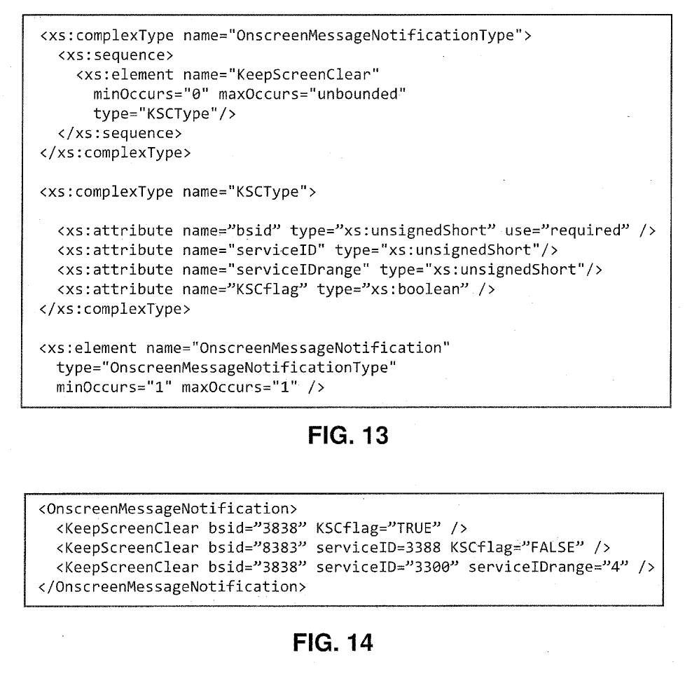

In this manner, OnscreenMessageNotification, KeepScreenClear, @bsid, @serviceID, @serviceIDrange, and @KSCflag in Table 7 may be used by a service provider to signal a notification of on-screen information, e.g., burnt-in crawl text and/or graphics. It should be noted that with respect to @ serviceIDrange that services within the range may not all be active. It should be noted that @ KSCflag being TRUE may indicate that a notification is currently displayed in a video stream. FIG. 13 is a computer program listing illustrated an example of an onscreen notification communication message formatted according to a schema according to one or more techniques of this disclosure. In the example illustrated in FIG. 13, the example XML schema is based on the example illustrated in Tables 4B and Table 7. It should be noted that while the example indicated XML schema in FIG. 13 specifies the normative syntax of a OnscreenMessageNotification element, Table 7 may be used to describe the structure of the OnscreenMessageNotification element in a more illustrative way.

FIG. 14 is a computer program listing illustrating an example of onscreen notification communication messages formatted according to a schema according to one or more techniques of this disclosure. In the example illustrated in FIG. 14, the example messages are based on the schema illustrated in FIG. 13. In the example illustrated in FIG. 14, a first KeepScreenClear message sets KSCflag TRUE for all services in broadcast stream 3838 (e.g., indicating that an onscreen notification is burnt-in to all services associated with broadcast stream 3838), a second KeepScreenClear message sets KSCflag FALSE for service 3388 in broadcast stream 8383 (e.g., indicating that an onscreen notification is not burnt-in to service 3388 in broadcast stream 8383), and a third KeepScreenClear message sets KSCflag FALSE for services 3300-3304 in broadcast stream 3838 (i.e., in the third KeepScreenClear message KSCflag is not present and inferred to be false for identified services). It should be noted that in the example where broadcast stream 3838 includes service 3305 in addition to services 3300-3304, the first KeepScreenClear message in the example illustrated in FIG. 14 sets KSCflag TRUE for service 3305 and the third message KeepScreenClear message in the example illustrated in FIG. 14 has no effect on the KSCflag for service 3305 (i.e., it remains TRUE).

It should be noted that with respect to Table 7, the use of KeepScreenClear is 0 . . . N, thus, an instance of a OnscreenMessageNotification may be as follows:

<OnscreenMessageNotification>

</OnscreenMessageNotification>

and would indicate that no notification is present for any combination of services and broadcast streams.

It should be noted that in other examples, @KSCflag in Table 7 may be based on the following semantics:

@KSCflag—indicates the status of the KeepScreenClear for the identified services within the identified broadcast stream. If not present, @ KSCflag is inferred to have the value TRUE.

In this case where @ KSCflag is inferred to have the value TRUE if not present, a message:

<KeepScreenClear bsid=“3838” serviceID=“3300” serviceIDrange=“4” I> sets KSCflag TRUE for services 3300-3304 in broadcast stream 3838.

In one example, @KSCflag in Table 7 may be based on the following semantics:

@KSCflag—indicates the status of the KeepScreenClear for the identified services within the identified broadcast stream. If not present, @ KSCflag is inferred to have the value TRUE for identified services.

In this case where @KSCflag is inferred to have the value TRUE for identified services if not present, in one example, a message:

<OnscreenMessageNotification>

<KeepScreenClear bsid=“3838” serviceID=“3300” I>

</OnscreenMessageNotification>

sets KSCflag TRUE for service 3300 in broadcast stream 3838 and sets KSCflag FALSE for all other services in broadcast stream 3838.

In another example, the inferred value of the KSCflag may depend on if a KeepScreenClear service information for an identified service is present in an OnscreenMessageNotification. For example, the value of the KSCflag may be inferred to be TRUE if KeepScreenClear service information for an identified service is present in an OnscreenMessageNotification, and the value of the KSCflag may be inferred to be FALSE if KeepScreenClear service information for an identified service is not present in said OnScreenMessageNotification. In this case, a message:

<OnscreenMessageNotification>

<KeepScreenClear bsid=“3838” serviceID=“3300” I>

</OnscreenMes sageNotification>

sets KSCflag TRUE for service 3300 in broadcast stream 3838 and sets KSCflag FALSE for all other services in broadcast stream 3838.

In one example, KeepScreenClear, @serviceIDrange, and @KSCflag in Table 7 may be based on the following example semantics:

KeepScreenClear—Conveys information for service(s) regarding keep screen clear status.

@ serviceIDrange—specifies the range of services within the scope of the broadcast stream that this notification applies to. @serviceIDrange shall not be present when @serviceID is not present. When @ serviceID is present and @ serviceIDrange is not present, it is inferred to have the value 0. The KeepScreenClear element applies to the services identified by the identifier numbers starting from @ serviceID to @serviceID+@serviceIDrange inclusive in the broadcast stream identified by @bsid.

@KSCflag—indicates the status of the KeepScreenClear element for the identified services within the identified broadcast stream. If not present, @ KSCflag is inferred to have the value TRUE for identified services and have the value of FALSE for all services for the broadcast stream identified by @bsid which are not identified by any KeepScreenClear element inside the parent OnScreenMessageNotification element. If an OnscreenMessageNotification element does not include any KeepScreenClear element then @ KSCflag is inferred to be equal to FALSE for all the services for all the broadcast streams.

In one example, a version and/or an identification attribute may be present in the KeepScreenClear element. A version or identification attribute may associate a version or identification value with a particular instance of information regarding a keep screen clear status. In one example, a receiver device may determine a first on screen event and second on screen event, etc. based on values of a version and/or identification attribute. In one example, a receiver device may be configured to accept input, (e.g., from a user through an interface) to alter the processing of a KeepScreenClear element based on a version and/or an identification attribute. For example, a receiver device may be configured to process a KeepScreenClear element associated with a first identification value in a distinct manner than a KeepScreenClear element associated with a second identification value. In one example, a receiver device may be configured to accept input indicating a user preference for a receiver device to disregard instances of KeepScreenClear elements associated with particular identification and/or version values (e.g., 5, etc.). In some examples, a receiver device disregarding KeepScreenClear elements associated with particular identification and/or version values may cause a receiver device to not perform one or more functions that the receiver device would otherwise perform upon receiving an instance of a KeepScreenClear element.

In some examples, an attribute may be present in the KeepScreenClear element to enable a service provider to indicate multiple notifications for a particular service. For example, a service provider may want to indicate that both a hurricane warning and a school closing notification are directly integrated into a video component. In one example, an id attribute including an unsigned integer data type may be present in the KeepScreenClear element to indicate multiple notifications for a particular service. In one example, an id attribute including a string data type may be present in the KeepScreenClear element to indicate multiple notifications for a particular service. In this case, a message:

<OnscreenMessageNotification>

<KeepScreenClear bsid=“3838” serviceID=“3300” id=“1” id=“2”/>

</OnscreenMessageNotification>

Or a message:

<OnscreenMessageNotification>

<KeepScreenClear bsid=“3838” serviceID=“3300” id=“hurricane” id=“closing”/>

</OnscreenMessageNotification>

sets KSCflag TRUE for service 3300 in broadcast stream 3838 and indicates multiple notifications for service 3300. In one example, an id attribute may be used to indicate that one or more of multiple notifications previously integrated into a particular service are no longer integrated into the particular service. In this case, a message:

<OnscreenMessageNotification>

<KeepScreenClear bsid=“3838” serviceID=“3300” id=“2”/>

</OnscreenMessageNotification>

Or a message:

<OnscreenMessageNotification>

<KeepScreenClear bsid=“3838” serviceID=“3300” id=“closing”/>

</OnscreenMessageNotification>

may indicate that the hurricane warning, in the example described above, is no longer directly integrated into a video component. In one example, a receiver device may be configured to render an onscreen presentation based on a determination that one or more of multiple notifications previously integrated into a particular service are no longer integrated into the particular service.

In one example, OnscreenMessageNotification may include the elements and attributes illustrated in Table 8A.

TABLE 8A

| Element or Attribute Name | Use | Data Type | Description |
|---|---|---|---|
| OnscreenMessageNotification | 1 | | |
| @bsid | 1 | unsignedShort | Identifier of the |
| | | | broadcast stream. |
| ServiceNotificationInfo | 0 . . . N | | Service Information |
| | | | related to Onscreen |
| | | | Message Notification |
| @serviceID | 1 | unsignedShort | Identifier of the |
| | | | service within the |
| | | | scope of the |
| | | | broadcast stream that |
| | | | the notification |
| | | | applies. |
| @serviceIDrange | 0 . . . 1 | unsignedShort | Identifier of a range |
| | | | of serviceID that this |
| | | | notification applies. |
| @NotificationStart | 0 . . . 1 | dateTime | Indicates the date and |
| | | | time that the |
| | | | notification starts. |
| @NotificationDuration | 0 . . . 1 | duration | Indicates the duration |
| | | | of the notification. |
| @KeepScreenClear | 0 . . . 1 | boolean | Boolean flag to |
| | | | indicate notification is |
| | | | ON/OFF. |

In one example, OnscreenMessageNotification, @bsid, ServiceNotificationInfo, @serviceID, @serviceIDrange, @NotificationStart, @NotificationDuration, and @KeepScreenClear in Table 8 may be based on the following semantics:

OnscreenMessageNotification—root element contains broadcaster, service, and timing information for on-screen important text/visual information, including emergency-related, information that has been rendered by broadcasters on their video service(s).

@bsid—Identifier of the whole Broadcast Stream. The value of bsid shall be unique on a regional level (for example, North America). An administrative or regulatory authority may play a role.

ServiceNotificationInfo—Service Information related to the OnscreenMessageNotification. If not present all services in the bsid with value @bsid are inferred to have value of @ KeepScreenClear equal to FALSE.

@ serviceID—16-bit integer that shall uniquely identify this Service within the scope of this Broadcast area.

@ serviceIDrange—specifies the range of services within the scope of the broadcast stream. @ serviceIDrange shall not be present when @ serviceID is not present. When @ serviceID is present and @ serviceIDrange is not present, the service ID range is inferred to have the value 0. When @ serviceIDrange is present, the Notification applies to the services identified by the identifier numbers starting from @ serviceID to @ServiceID+@serviceIDrange in the broadcast stream identified by @bsid.

@NotificationStart—when present, specifies the date time information when on-screen text/visual rendering event begins. When @ start is not present, the default start time is the current time.

@NotificationDuration—when present, specifies the duration in time starting at @ start or current time if @ start is not present, for which the on-screen text/visual rendering event is valid. @duration of value of “PTOS” is reserved to signal Cancellation of the OnscreenMessageNotification.

@ KeepScreenClear—when present, a value set to TRUE indicates that the notification is current active, and when value is set to FALSE, indicates that the notification is current inactive.

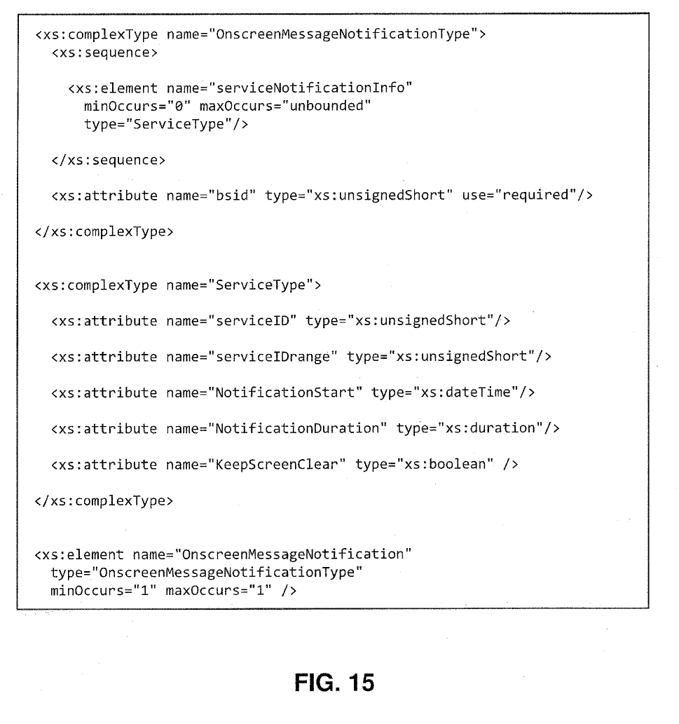

In this manner, OnscreenMessageNotification, @bsid, ServiceNotificationInfo, @serviceID, @serviceIDrange, @NotificationStart, @NotificationDuration, and @ KeepScreenClear in Table 8A may be used by a service provider to signal a notification of on-screen information. It should be noted that in one example, an instance of a message may be constrained to signal one of an @NotificationStart, @NotificationDuration pair or @KeepScreenClear. FIG. 15 is a computer program listing illustrated an example of an onscreen notification communication message formatted according to a schema according to one or more techniques of this disclosure. In the example illustrated in FIG. 15, the example XML schema is based on the example illustrated in Tables 4B and Table 8A.

In one example, OnscreenMessageNotification may include the elements and attributes illustrated in Table 8B.

TABLE 8B

| Element or Attribute Name | Use | Data Type | Description |
|---|---|---|---|
| OnscreenMessageNotification | 1 | | |
| ServiceNotificationInfo | 0 . . . N | | Service Information |
| | | | related to Onscreen |
| | | | Message Notification |
| @bsid | 1 | unsignedShort | Identifier of the |
| | | | broadcast stream. |
| @serviceID | 1 | unsignedShort | Identifier of the |
| | | | service within the |
| | | | scope of the |
| | | | broadcast stream that |
| | | | the notification |
| | | | applies. |
| @serviceIDrange | 0 . . . 1 | unsignedShort | Identifier of a range |
| | | | of serviceID that this |
| | | | notification applies. |
| @NotificationDuration | 0 . . . 1 | duration | Indicates the duration |
| | | | of the notification. |
| @KeepScreenClear | 0 . . . 1 | boolean | Boolean flag to |
| | | | indicate notification |
| | | | is ON/OFF. |

In one example, OnscreenMessageNotification, ServiceNotificationInfo, @bsid, @serviceID, @serviceIDrange, @ NotificationDuration, and @ KeepScreenClear in Table 8B may be based on the following semantics:

OnscreenMessageNotification—root element contains broadcaster, service, and timing information for on-screen important text/visual information, including emergency-related, information that has been rendered by broadcasters on their video service(s).

ServiceNotificationInfo—Service Information related to the OnscreenMessageNotification.

@bsid—Identifier of the whole Broadcast Stream. The value of bsid shall be unique on a regional level (for example, North America). An administrative or regulatory authority may play a role.

@ serviceID—16-bit integer that shall uniquely identify this Service within the scope of this Broadcast area.

@ serviceIDrange—specifies the range of services within the scope of the broadcast stream. @ serviceIDrange shall not be present when @ serviceID is not present. When

@ serviceID is present and @ serviceIDrange is not present, the service ID range is inferred to have the value 0. When @ serviceIDrange is present, the Notification applies to the services identified by the identifier numbers starting from @ serviceID to @ServiceID+@serviceIDrange in the broadcast stream identified by @bsid.

@NotificationDuration—This value shall be the duration of the ServiceNotificationInfo element for the identified services within the identified broadcast stream. For the purpose of counting, time starts at the current time of the OnscreenMessageNotification. In an example, current time is the time when a receiver receives the signaling corresponding to OnscreenMessageNotification (i.e., reception time). In one example, a receiver device may define receiving signaling as one or more of detecting, decoding and/or parsing. If not present, @NotificationDuration shall be set to a default value (e.g., “PT1M”, i.e., one minute). In one example, a duration greater than a particular value may be indicated by the particular value. For example, in one example, a @NotificationDuration value greater than 1 hour shall be set to “PT1H”, i.e., 1 hour. A @NotificationDuration value of 0 or less shall be considered invalid. The @ KeepScreenClear of the identified services within the identified broadcast stream shall be set to FALSE by a receiver device when current time reaches or exceeds (OnscreenMessageNotification reception time+@notificationDuration). @ KeepScreenClear—when present, a value set to TRUE indicates that the notification is current active, and when value is set to FALSE, indicates that the notification is current inactive.

FIG. 12 is a block diagram illustrating an example of a receiver device that may implement one or more techniques of this disclosure. That is, receiver device 400 may be configured to parse a signal based on the semantics described above with respect to one or more of the tables described above. Further, receiver device 400 may be configured to ensure that an onscreen message including, for example, an emergency alert message, directly integrated into the presentation of a multimedia content is apparent to a user in response to a signal based on the semantics described above. For example, a receiver device may be configured to temporally suspend applications and/or change how a multimedia presentation is rendered (e.g., for a specified duration for one or more services) in order to increase the likelihood that a user is aware of the onscreen message including, for example, an emergency alert message. Further, in one example receiver device 400 may be configured to enable a user to set how on-screen messages including, for example, emergency message notifications are handled by receiver device 400. For example, a user may set one of the following a preferences in a settings menu: a preference that corresponds to always being alerted, a preference that correspond to an frequency at which a user is alerted (e.g., only alert once every five minute), a preference that corresponds to never being alerted. In the case, where a setting corresponds to a user being alerted and an emergency alert message notification (e.g., a EmergencyOnscreenNotification) is received, receiver device 400 may determine if the EmergencyOnscreenNotification corresponds to the currently rendered service. For example, the receiver device 400 may determine if a serviceID in the EmergencyOnscreenNotification matches a service that is currently being displayed. Further, receiver device 400 may determine whether a current time is equal or greater than an @start value and less than a value of the sum of @start and @duration. If the current time is within the range of @start and the sum of @start and @duration, receiver device 400 may minimize (and/or “takes down”) graphic overlays that are currently being displayed. In some cases, depending on implementation, this can be done by setting the transparency of a graphic plane to full-transparent. In this manner, receiver device 400 may cause a service with serviceID in the EmergencyOnscreenNotification to be rendered in a full-screen view with minimal or no graphic overlays obstructing an emergency alert message. When the current time becomes greater than the sum of @start and @duration, receiver device 400 may restores its graphic plane to its previous state.

In one example, receiver device 400 may be configured to receive the OnScreenNotification message based on any combination of the example semantics described above, parse it, and then take an action. For example, receiver device 400 may receive an OnScreenNotification message and if the message indicates a value of true for a KSCFlag for a service being accessed (e.g., being displayed), receiver device 400 may cause any overlays or applications to cease being displayed. In some instances, receiver device may perform necessary scaling function to enable full visibility of a video for display. Further, in one example, receiver device 400 may receive an OnScreenNotification message and if the message indicates a value of false for a KSCFlag for a service being accessed (e.g., being displayed), receiver device 400 may cause any overlays or applications to be displayed (e.g., resume display of an application).

Receiver device 400 is an example of a computing device that may be configured to receive data from a communications network via one or more types of data channels and allow a user to access multimedia content. In the example illustrated in FIG. 12, receiver device 400 is configured to receive data via a television network, such as, for example, television service network 204 described above. Further, in the example illustrated in FIG. 12, receiver device 400 is configured to send and receive data via a wide area network. It should be noted that in other examples, receiver device 400 may be configured to simply receive data through a television service network 204. The techniques described herein may be utilized by devices configured to communicate using any and all combinations of communications networks.

As illustrated in FIG. 12, receiver device 400 includes central processing unit(s) 402, system memory 404, system interface 410, data extractor 412, audio decoder 414, audio output system 416, video decoder 418, display system 420, I/O device(s) 422, and network interface 424. As illustrated in FIG. 12, system memory 404 includes operating system 406, applications 408, and document parser 409. Each of central processing unit(s) 402, system memory 404, system interface 410, data extractor 412, audio decoder 414, audio output system 416, video decoder 418, display system 420, I/O device(s) 422, and network interface 424 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 400 is illustrated as having distinct functional blocks, such an illustration is for descriptive purposes and does not limit receiver device 400 to a particular hardware architecture. Functions of receiver device 400 may be realized using any combination of hardware, firmware and/or software implementations.

CPU(s) 402 may be configured to implement functionality and/or process instructions for execution in receiver device 400. CPU(s) 402 may include single and/or multi-core central processing units. CPU(s) 402 may be capable of retrieving and processing instructions, code, and/or data structures for implementing one or more of the techniques described herein. Instructions may be stored on a computer readable medium, such as system memory 404.

System memory 404 may be described as a non-transitory or tangible computer-readable storage medium. In some examples, system memory 404 may provide temporary and/or long-term storage. In some examples, system memory 404 or portions thereof may be described as non-volatile memory and in other examples portions of system memory 404 may be described as volatile memory. System memory 404 may be configured to store information that may be used by receiver device 400 during operation. System memory 404 may be used to store program instructions for execution by CPU(s) 402 and may be used by programs running on receiver device 400 to temporarily store information during program execution. Further, in the example where receiver device 400 is included as part of a digital video recorder, system memory 404 may be configured to store numerous video files.

Applications 408 may include applications implemented within or executed by receiver device 400 and may be implemented or contained within, operable by, executed by, and/or be operatively/communicatively coupled to components of receiver device 400. Applications 408 may include instructions that may cause CPU(s) 402 of receiver device 400 to perform particular functions. Applications 408 may include algorithms which are expressed in computer programming statements, such as, for-loops, while-loops, if-statements, do-loops, etc. Applications 408 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 400 includes a smart television, applications may be developed by a television manufacturer or a broadcaster. As illustrated in FIG. 12, applications 408 may execute in conjunction with operating system 406. That is, operating system 406 may be configured to facilitate the interaction of applications 408 with CPUs(s) 402, and other hardware components of receiver device 400. Operating system 406 may be an operating system designed to be installed on set-top boxes, digital video recorders, televisions, and the like. It should be noted that techniques described herein may be utilized by devices configured to operate using any and all combinations of software architectures.

As described above, an application may be a collection of documents constituting an enhanced or interactive service. Further, document may be used to describe an emergency alert or the like according to a protocol. Document parser 409 may be configured to parse a document and cause a corresponding function to occur at receiver device 400. For example, document parser 409 may be configured to parse a URL from a document and receiver device 400 may retrieved data corresponding to the URL.

System interface 410 may be configured to enable communications between components of receiver device 400. In one example, system interface 410 comprises structures that enable data to be transferred from one peer device to another peer device or to a storage medium. For example, system interface 410 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 400 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 12, data extractor 412 may be configured to extract video, audio, and data from a signal. A signal may be defined according to, for example, aspects DVB standards, ATSC standards, ISDB standards, DTMB standards, DMB standards, and DOCSIS standards. Data extractor 412 may be configured to extract video, audio, and data, from a signal generated by service distribution engine 300 described above. That is, data extractor 412 may operate in a reciprocal manner to service distribution engine 300.

Data packets may be processed by CPU(s) 402, audio decoder 414, and video decoder 418. Audio decoder 414 may be configured to receive and process audio packets. For example, audio decoder 414 may include a combination of hardware and software configured to implement aspects of an audio codec. That is, audio decoder 414 may be configured to receive audio packets and provide audio data to audio output system 416 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3, AC-4, etc.) formats. Audio output system 416 may be configured to render audio data. For example, audio output system 416 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 418 may be configured to receive and process video packets. For example, video decoder 418 may include a combination of hardware and software used to implement aspects of a video codec. In one example, video decoder 418 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 420 may be configured to retrieve and process video data for display. For example, display system 420 may receive pixel data from video decoder 418 and output data for visual presentation. Further, display system 420 may be configured to output graphics in conjunction with video data, e.g., graphical user interfaces. Display system 420 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 422 may be configured to receive input and provide output during operation of receiver device 400. That is, I/O device(s) 422 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 422 may be operatively coupled to receiver device 400 using a standardized communication protocol, such as for example, Universal Serial Bus protocol (USB), Bluetooth, ZigBee or a proprietary communications protocol, such as, for example, a proprietary infrared communications protocol.

Network interface 424 may be configured to enable receiver device 400 to send and receive data via a local area network and/or a wide area network. Network interface 424 may include a network interface card, such as an Ethernet card, an optical transceiver, a radio frequency transceiver, or any other type of device configured to send and receive information. Network interface 424 may be configured to perform physical signaling, addressing, and channel access control according to the physical and Media Access Control (MAC) layers utilized in a network. Receiver device 400 may be configured to parse a signal generated according to any of the techniques described above with respect to FIG. 12. In this manner, receiver device 400 represents an example of a device configured to modify the presentation of a service in response to an onscreen message including, for example, emergency alert message notification.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1. A method for signaling whether a message is directly integrated into a video component forming a service, the method comprising:
signaling a value indicating an instance of a low level notification fragment has a type associated with messages directly integrated into a video component forming a service; and
signaling values for one or more syntax elements included in the instance of the notification fragment indicating whether a message is directly integrated into a video component for a particular service.

2. The method of claim 1, wherein the one or more syntax elements includes an attribute specifying an identifier of a broadcast stream.

3. The method of claim 2, wherein the one or more syntax elements includes an attribute specifying a unique identifier for a service within the scope of the broadcast stream.

4. The method of claim 3, wherein the one or more syntax elements includes an attribute specifying a range of services within the scope of the broadcast stream.

5. The method of claim 2, wherein the one or more syntax elements includes an attribute identifying a duration for which a message is directly integrated into a video component.

6. The method of claim 2, wherein the one or more syntax elements includes an attribute identifying a flag indicating an on or off state for a message directly integrated into a video component.

7. The method of claim 1, wherein the notification fragment includes a mark-up language fragment.

8. The method of claim 1, wherein a low level notification fragment includes a fragment included in an Internet Protocol packet.

9. A method for modifying the presentation of a service in response to a notification message, the method comprising:
receiving an instance of a low level notification fragment having a type associated with messages directly integrated into a video component forming a service;
determining that a notification message is directly integrated into a media component forming a service by parsing information from the notification fragment; and
modifying the presentation of the service based on the determination of whether a notification message is directly integrated into a media component forming the service.

10. The method of claim 9, wherein parsing information from the notification fragment includes parsing an attribute specifying an identifier of a broadcast stream.

11. The method of claim 10, wherein parsing information from the notification fragment includes parsing an attribute specifying a unique identifier for a service within the scope of the broadcast stream.

12. The method of claim 11, wherein parsing information from the notification fragment includes parsing an attribute specifying a range of services within the scope of the broadcast stream.

13. The method of claim 10, wherein parsing information from the notification fragment includes parsing an attribute identifying a duration for which a message is directly integrated into a video component.

14. The method of claim 10, wherein parsing information from the notification fragment includes parsing an attribute identifying a flag indicating an on or off state for a message directly integrated into a video component.

15. A device comprising a non-transitory computer readable storage medium and one or more processors configured to:
receive an instance of a low level notification fragment having a type associated with messages directly integrated into a video component forming a service;
determine that a notification message is directly integrated into a media component forming a service by parsing information from the notification fragment; and
modify the presentation of the service based on the determination of whether an notification message is directly integrated into a media component forming the service.

16. The device of claim 15, wherein parsing information from the notification fragment includes parsing an attribute specifying an identifier of a broadcast stream.

17. The device of claim 16, wherein parsing information from the notification fragment includes parsing an attribute specifying a unique identifier for a service within the scope of the broadcast stream.

18. The device of claim 17, wherein parsing information from the notification fragment includes parsing an attribute specifying a range of services within the scope of the broadcast stream.

19. The device of claim 17, wherein parsing information from the notification fragment includes parsing an attribute identifying a duration for which a message is directly integrated into a video component.

20. The device of claim 17, wherein parsing information from the notification fragment includes parsing an attribute identifying a flag indicating an on or off state for a message directly integrated into a video component.
